(19) United States
(12) Patent Application Publication
(10) Pub. No.: US 2006/0224559 A1
(43) Pub. Date: Oct. 5, 2006

(54) Job processing method, job processing device, and storage medium

(75) Inventor: Osamu Abiko, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/393,996

(22) Filed: Mar. 30, 2006

(30) Foreign Application Priority Data
Mar. 30, 2005 (JP) 2005-099538

(51) Int. Cl. G06F 17/30

(52) U.S. Cl. 707/1

(57) ABSTRACT

To enable a process in conformity with operator's request in recovery of interrupted job, it accepts a request for executing in the job recovery a process according to operator's request in the job of which process was interrupted by occurrence of interruption cause; it executes in the job recovery the process based on the request after interruption cause is released; and it accepts at least one of second and third type recovery requests, different from first type recovery request for causing to execute, in the job recovery, the process interrupted by occurrence of interruption cause without executing the process already executed before interruption cause occurs, the second type recovery request causes to again execute in the job recovery the process already executed before interruption cause occurs, and the third type recovery request causes to skip in job recovery the process not executed before interruption cause occurs.

### BACKGROUND OF THE INVENTION

1. Field of the Invention

The present invention relates to a job processing method to be applied to a system which comprises a job processing device capable of executing a process necessary in a job, the job processing device, and a storage medium for storing a program to execute the job processing method.

2. Related Background Art

In recent years, since the operation speed and the printed-image quality of an electrophotographic print device and an inkjet print device increase, a print method called a POD (print on demand) by which digital data is directly printed on a recording medium without executing a plate making step and a blanket making step both necessary in the conventional offset printing is achieved.

By adopting the POD, small-lot large-item printing and quick delivery printing can be attained. For these reasons, there are the following advantages that excessive stocks of the printed materials can be eliminated, that variable printing of changing the content with respect to each print can be easily executed, that dispersion printing of dispersing one data to plural image forming devices through a communication function and then printing the dispersed data by the respective image forming devices, and the like. Consequently, it is expected in the printing industry that the POD will become the mainstream of the printing method in the future.

In the actual printing scene, the image forming devices such as a printer, a copying machine and the like, the image input devices such as a scanner and the like, the postprocessing devices of executing a binding process, a stapling process, a covering process, a gluing process, a punching process and the like, and the like are mutually connected through the network, and a print job generated on the client computer, a print job entered through the Internet, and the like are subjected to a print process.

Further, in the recent image processing devices such as the printer, the copying machine and the like, if an error such as a paper jam or the like occurs, it is proposed to be able to automatically restart the once-interrupted process after the cause of the error was eliminated by the operator (for example, Japanese Patent Application Laid-Open No. H04-305777).

Furthermore, the image forming device which outputs and prints, when a paper jam occurs, the jam information representing the place where the relevant jam occurs, the number of pages which have been printed up to then, the page number from which the print should restart, and the like is being proposed.

However, in the conventional case where the process of the job under execution by the image forming device is interrupted because of the occurrence of error and then the device can automatically restart the interrupted process based on its own judgment according as the cause of the error was eliminated by the operator, the following problems might occur.

For example, there is a possibility that the fundamentally desired print restart process is not executed appropriately and thus “page missing” and “page redundancy” which are inadmissible in the scene of the POD occur.

More specifically, in the case where the paper jam occurs, it is conceivable to dispose numbers of sensors respectively at appropriate locations for detecting the location where the paper jam occurs in order to restart the print process without “page missing” and “page redundancy”. However, since the number of sensors capable of being disposed is actually limited, the sensors are disposed only at the important locations, whereby there is a possibility that the accurate jam location information representing the accurate location where the jam occurs cannot be acquired. As a result, the image forming device determines the print restart location substantially based on the inaccurate jam location information not representing the accurate location where the jam occurs, whereby there is a possibility that “page missing” and “page redundancy” occur.

Further, in order to restart the print process without “page missing” and “page redundancy”, it is conceivable to accurately manage the information representing the count value of the jobs concerning the relevant print process, the count value of the pages to which the print output has been actually executed, the page number where the jam occurs, and the like.

However, in such a method, since the process becomes complicated, the process speed decreases, and the memory area to be used to compare the stored image data with the input image data for specifying the page is necessary. Further, it is necessary to photograph the actual output image by using a camera at the final stage of the print output. That is, by these problems, it is conceivable that the relevant method is not practicable in terms of cost.

Therefore, as described above, if the constitution of automatically recovering the jammed state in the image forming device is applied, it is expected that the operator has to manually check the print-output papers to prevent “page missing” and “page redundancy”, and such an operation will impose a heavy burden to the relevant operator. Moreover, when the paper jam occurs, it is expected that, to prevent “page missing” and “page redundancy”, the papers output partway are discarded and the print output of the same contents is again executed to the papers from the beginning, whereby the resultingly output number of copies remarkably exceeds the originally requested number of copies. Thus, it is conceivable that the problems occur in regard to cost and resource saving.

### SUMMARY OF THE INVENTION

An object of the present invention is to provide a job processing method which can solve the above problems, a job processing device which can adopt the relevant job processing method, and a storage medium which can store the program to execute the relevant job processing method.

Another object of the present invention is to provide a job processing method which can execute recovery of the job in which the process based on to an operator's request has been interrupted, as eliminating page missing and page redundancy with the simple and inexpensive constitution, a job processing device which can adopt the relevant job processing method, and a storage medium which can store the program to execute the relevant job processing method.

Other objects and features of the present invention will be apparent from the following description in conjunction with the accompanying drawings.

### BRIEF DESCRIPTION OF THE DRAWINGS

FIG. 1 is a diagram showing the whole configuration of an image processing system to which the image processing device according to the embodiment of the present invention is applied;

FIG. 2 is a diagram showing the outer appearance of an MFP (multifunctional peripheral) which acts as an image processing device 131 provided in a digital printing unit 130 shown in FIG. 1;

FIG. 3 is a block diagram showing the constitution of the MFP;

FIG. 4 is a plan view showing the operation unit of the MFP;

FIG. 5 is a diagram showing a basic GUI (graphical user interface) screen to be displayed on the operation unit of the MFP;

FIG. 6 is a flow chart showing a recovery initial value setting process;

FIG. 7 is a diagram showing the GUI screen concerning a user mode;

FIG. 8 is a diagram showing the GUI screen concerning common specification setting;

FIG. 9 is a diagram showing the GUI screen for setting a restart mode concerning the print recovery function;

FIG. 10 is a diagram showing the GUI screen for setting timeout concerning the print recovery function;

FIG. 11 is a diagram showing the GUI screen for setting a restart location concerning the print recovery function;

FIG. 12 is a diagram showing the GUI screen for setting an initial thumbnail image display number concerning the print recovery function (in case of setting “5” as the initial thumbnail image display number);

FIG. 13 is a flow chart showing a recovery process to be executed when the cause of interruption occurs;

FIG. 14 is a flow chart showing the detailed process in steps S1304 to S1306 of FIG. 13;

FIG. 15 is a diagram showing the screen for notifying that a paper jam occurs;

FIG. 16 is a diagram showing the GUI screen for designating a print output restart page;

FIG. 17 is a diagram showing the GUI screen for selecting whether to restart the printing from the interrupted copy or to designate the copy number;

FIG. 18 is a diagram showing the GUI screen for designating the copy number;

FIG. 19 is a diagram showing an example of a print job;

FIG. 20 is a diagram showing an example that an interruption occurs in the print job shown in FIG. 19;

FIG. 21 is a diagram showing an example of the GUI screen for designating the output restart page (default-designated state; corresponding to FIG. 19);

FIG. 22 is a diagram showing an example of the GUI screen for designating the output restart page (in case of changing the default-designated state shown in FIG. 19);

FIG. 23 is a diagram showing the print restart location corresponding to the designation in FIG. 22;

FIG. 24 is a diagram showing a second example of the GUI screen for selecting whether to restart the printing from the interrupted copy or to designate the copy number;

FIG. 25 is a diagram showing the print restart location in case of selecting “RESTART FROM INTERRUPTION-OCCURRED COPY” on the GUI screen shown in FIG. 24;

FIG. 26 is a diagram showing an example of the GUI screen in case of selecting the “DESIGNATE COPY NUMBER” button on the GUI screen shown in FIG. 24 (default-designated state);

FIG. 27 is a diagram showing the state that the default-designated state shown in FIG. 26 has been changed;

FIG. 28 is a diagram showing the print restart location corresponding to the copy number designation shown in FIG. 27;

FIG. 29 is a diagram showing an example that an interruption occurs in a second example of the print job;

FIG. 30 is a diagram showing an example of the GUI screen for designating the output restart page (default-designated state; corresponding to FIG. 29);

FIG. 31 is a diagram showing an example of the GUI screen for designating the output restart page (in case of changing the default-designated state shown in FIG. 30);

FIG. 32 is a diagram showing the print restart location corresponding to the designation in FIG. 30;

FIG. 33 is a diagram showing the GUI screen for setting a restart mode concerning the transmission recovery function;

FIG. 34 is a diagram showing the GUI screen for designating the transmission output restart page;

FIG. 35 is a diagram showing the GUI screen for setting an initial thumbnail image display number concerning the print recovery function (3″ is set as the initial thumbnail image display number); and

FIG. 36 is a diagram showing the size of the thumbnail image corresponding to the setting shown in FIG. 35.

### DETAILED DESCRIPTION OF THE PREFERRED EMBODIMENTS

Hereinafter, the embodiments of the present invention will be explained in detail with reference to the accompanying drawings.

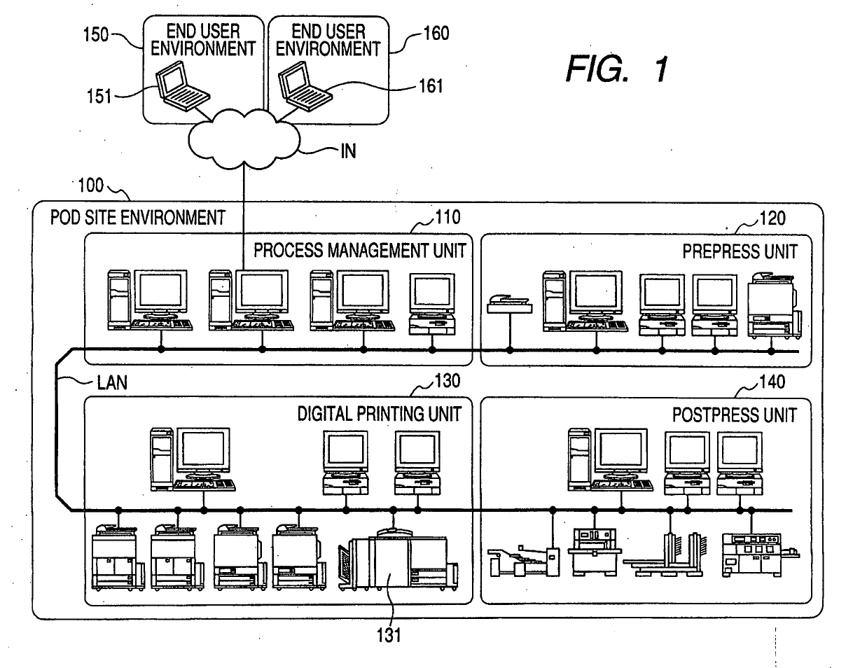

FIG. 1 is a diagram showing the whole configuration of an image processing system to which the image processing device according to the embodiment of the present invention is applied. Here, it should be noted that the image processing system is provided in one or plural end user environments 150 and 156 and a POD site environment 100 connected through the Internet IN.

In the end user environments 150 and 160, end users (i.e., orderers) can order printing and confirm the print job status concerning the relevant order by using respective client PC's 151 and 161. Moreover, in the POD site environment 100, a process management unit 110, a prepress unit 120, a digital printing unit 130 and a postpress unit 140 are connected through a LAN (local area network).

The process management unit 110 which unitarily manages the work flow of the image processing system is equipped with plural computers. In the process management unit 110, each computer indicates the processes of the process management unit 110, the prepress unit 120, the digital printing unit 130 and the postpress unit 140, receives and stores the jobs from the client PC's 151 and 161, constructs the processes of these units 110 to 140 based on the indications of the jobs, and effectively makes out the schedule of these processes.

The prepress unit 120 which generates the data to be printed is equipped with a scan device such as a scanner/MFP (scanner/multifunction peripheral) or the like, a prepress server, a computer and the like. Here, the scan device of the prepress unit 120 reads an image on the paper original received from the end user, and stores or transfers the image data corresponding to the read image in the prepress server or to the client PC's 151 and 161 as the scan image file, in response to the indication of the prepress job received from the process management unit 110.

The computer of the prepress unit 120 executes an image correction process, a file merge process, a page insertion/deletion process, various page layout editing processes, an imposition process, a proof output process for confirming the layout, the color and the like of the final printed material, and the like in regard to the image data of the document/image file of the job received from the client PC's 151 and 161 and stored by the process management unit 110 or the image data of the scan image file on the prepress server, in response to the indication of the prepress job.

The digital printing unit 130 which prints the print data is equipped with print devices (including an image processing device 131) such as a black/white MFP, a color MFP, a printer and the like, and a computer. Here, the print device of the digital printing unit 130 prints the image data of the document/image file or the image data of the scan image file based on the print job received from the process management unit 110 or the prepress unit 120. Incidentally, it should be noted that the image data (print-target image data) to be printed by the digital printing unit 130 includes the image data which has been subjected to the above various processes by the prepress unit 120. Further, in the following, the image processing device 131 is also called the MFP 131.

The postpress unit 140 executes various finishing processes such as a paper folding process, a saddle stitch bookbinding process, a case binding process, a cutting process, an enclosure process, a collation process and the like in regard to the recording paper print-processed and output by the digital printing unit 130. In this connection, the postpress unit 140 is equipped with various postprocessing devices such as a paper folding machine, a saddle stitch bookbinding machine, a case binding machine, a cutting machine, an enclosure machine, a collation machine and the like, and a computer for controlling the above postprocessing devices.

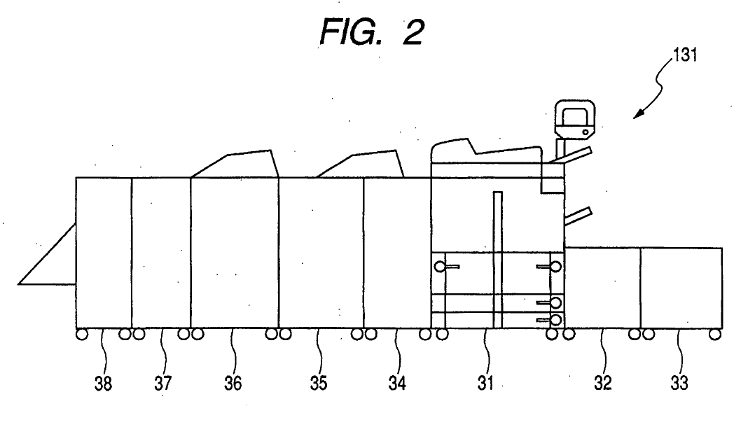

FIG. 2 is a diagram showing the outer appearance of the MFP which acts as the image processing device 131 provided in the digital printing unit 130 shown in FIG. 1. The image processing device 131 which is used in the POD is the large-scaled device as shown in FIG. 2 to which plural postprocessing devices such as an MFP main body 31 for actually forming the image, large-capacity paper feeding machines 32 and 33, a stacker 34, a case binding machine 35, a finisher 36, a paper folding machine 37, a cutting machine 38 and the like are connected. Further, the transportation path which is provided in the image processing device 131 for transporting the print papers or the like is remarkably long. Moreover, an automatic document feeder for automatically feeding the originals to the readout location, a display and the like are provided on the MFP main body 31.

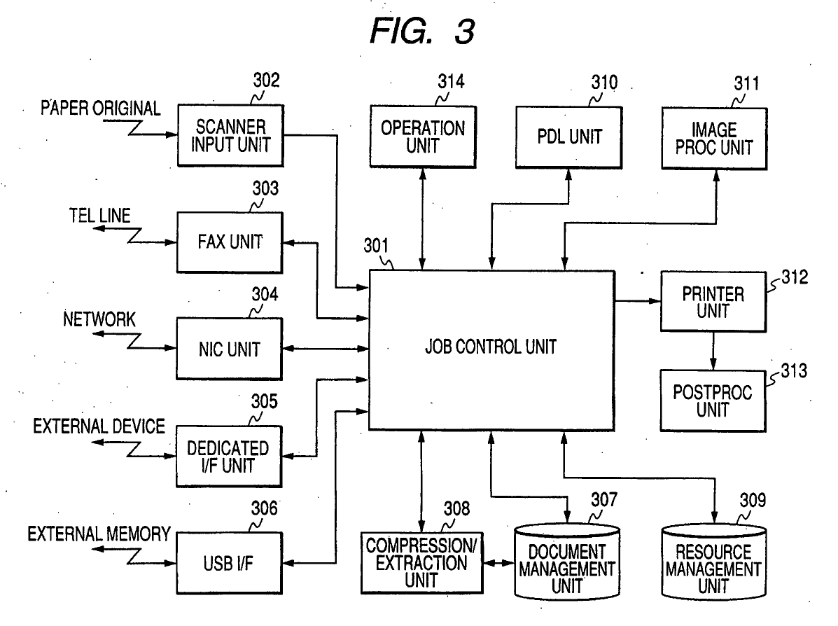

FIG. 3 is a block diagram showing the constitution of the MFP 131 shown in FIG. 2. Here, it should be noted that the MFP 131 has various functions such as a scanner function of reading an original image, a copy function of printing the read original image, a printer function of printing externally input image data, a facsimile function of executing facsimile transmission/reception, and the like.

To achieve the above functions under the control of a job control unit 301, a scanner input unit 302 for optically reading and converting the original on the document into the electronic image data and inputting the converted image data, a facsimile unit 303 for executing facsimile transmission/reception by using a telephone line, an NIC (network interface card) unit 304 for transmitting/receiving the image data and the like by using the network, a dedicated I/F (interface) unit 305 for transmitting/receiving the image data and the like to/from an external device, a USB (Universal Serial Bus) I/F unit 306 for transmitting/receiving the image data and the like to/from a USB device such as a USB memory (a kind of removable media), and the like are connected.

Moreover, a document management unit 307, a compression/extraction unit 308, a resource management unit 309, a PDL (page description language) unit 310, an image processing unit 311, a printer unit 312, and an operation unit 314 are connected to the job control unit 301. In addition, a postprocessing unit 313 is connected to the printer unit 312.

The document management unit 307 comprises a memory such as a hard disk or the like capable of storing plural image data. Thus, under the control of the job control unit 301, the document management unit 307 stores various image data input through the scanner input unit 302, the facsimile unit 303, the NIC unit 304, the dedicated I/F unit 305 and the USB I/F unit 306 in the hard disk, and then appropriately reads and transfers the stored image data to external devices such as a computer, another image forming device or the like.

The compression/extraction unit 308 executes a compression process or an extraction process in regard to the image data managed by the document management unit 307 and the image data to be transmitted and received through the NIC unit 304, under the control of the job control unit 301. Incidentally, the compression/extraction unit 308 executes the compression process or the extraction process in regard to the image data to be transmitted and received through the NIC unit 304, in a JPEG (Joint Photographic Experts Group) method, a JBIG (Joint Bi-level Image experts Group) method, a zip method or the like.

The resource management unit 309 stores and manages various tables concerning the parameters such as font parameters, color profile parameters, gamma correction values and the like. Thus, the resource management unit 309 reads and corrects the table data and stores a new table, under the control of the job control unit 301. Incidentally, it should be noted that the resource management table 309 stores and manages a recovery table (not shown) for registering various initial values concerning the later-described recovery operation.

The PDL unit 310 executes an RIP (raster image processor) process in regard to the PDL data input through the NIC unit 304 or the like, under the control of the job control unit 301. Further, the image processing unit 311 executes the image process such as a gamma correction process or the like in regard to the image data input from the scanner input unit 302, and converts the print-target image data into the bitmap data to be printed by the printer unit 312, under the control of the job control unit 301.

The printer unit 312, which consists of an electrophotographic printer, an inkjet printer or the like, prints the image data on a recording paper, and discharges the print-processed recording paper to the postprocessing unit 313, under the control of the job control unit 301. Further, the postprocessing unit 313 controls the paper postprocess to be executed in the stacker 34, the case binding machine 35, the finisher 36, the paper folding machine 37 and the cutting machine 38 respectively shown in FIG. 2. Incidentally, the detail of the operation unit 314 will be explained later.

The job control unit 301, which acts to smoothly execute the job, switches over various paths according to the functions as below. However, it should be noted that, in the following switchover, the path switchover to the compression/extraction unit 308, the postprocessing unit 313, the job control unit 301 being the whole core, and the like will be omitted. Further, with respect to the document management unit 307, only a case where the document management unit 307 is the start point or the end point will be described.

“copy function: scanner input unit 302→image processing unit 311→printer unit 312”

“facsimile transmission function: scanner input unit 302→facsimile unit 303”

“facsimile reception function: facsimile unit 303→image processing unit 311→printer unit 312”

“network scan function: scanner input unit 302→NIC unit 304”

“network print function: NIC unit 304→PDL unit 310→image processing unit 311→printer unit 312”

“scan function to external device: scanner input unit 302→dedicated I/F unit 305”

“print function from external device: dedicated I/F unit 305→PDL unit 310→image processing unit 311→printer unit 312”

“scan function to external memory: scanner input unit 302→USB I/F unit 306”

“print function from external memory: USB I/F unit 306→PDL unit 310→image processing unit 311→printer unit 312”

“box scan function: scanner input unit 302→image processing unit 311→document management unit 307”

“box print function: document management unit 307→printer unit 312”

“box reception function: NIC unit 304→PDL unit 310→image processing unit 311→document management unit 307”

“box transmission function: document management unit 307→NIC unit 304”

“preview function: document management unit 307→operation unit 314”

In addition, a combination with an electronic mail function, a Web server function or the like is conceivable. Incidentally, the box scan function, the box print function, the box reception function and the box transmission function are all the functions which use the document management unit 307, divide the memory area in the document management unit 307 with respect to each job or user, and input and output the data by using a user ID or a password.

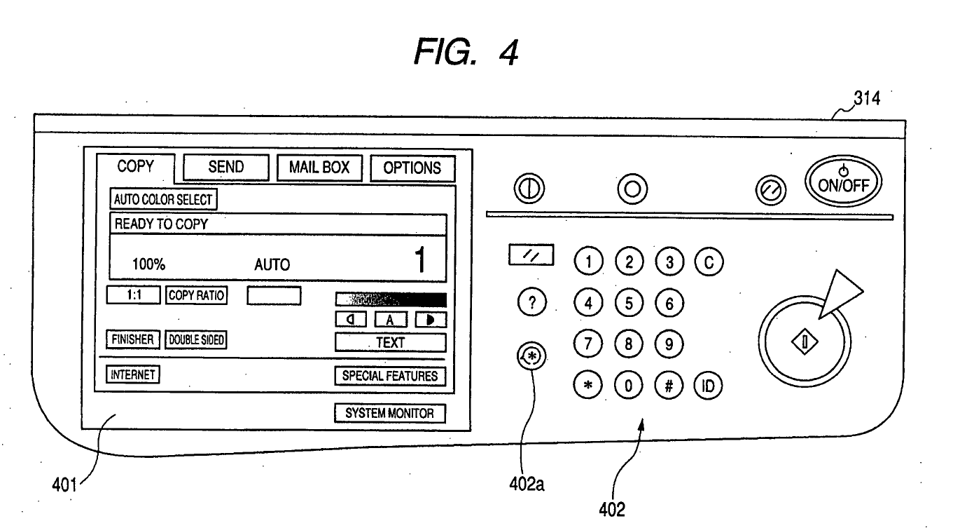

FIG. 4 is a plan view showing the configuration on the operation unit 314 shown in FIG. 3. Here, the operation unit 314, which functions as the user interface, consists of a GUI (graphical user interface) section 401 and a hard key section 402.

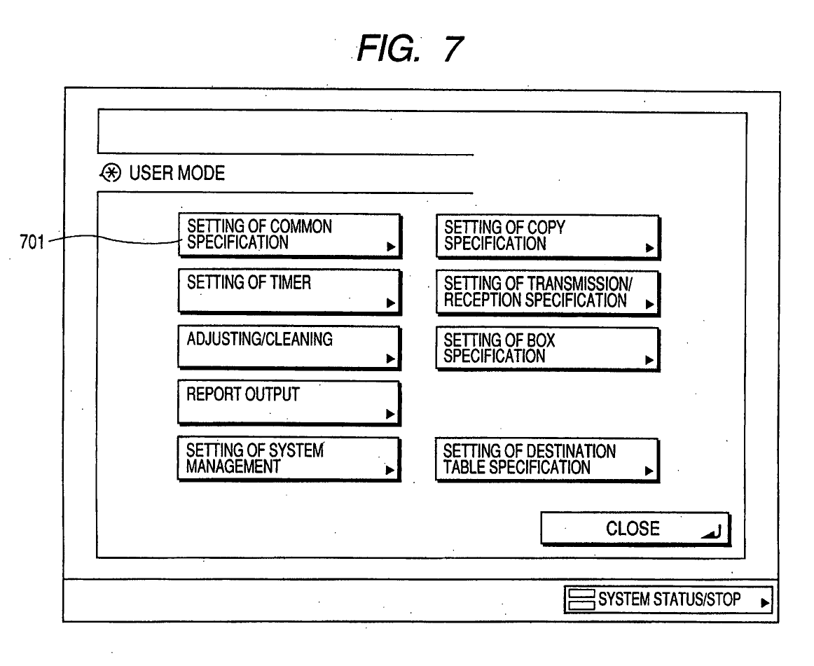

The GUI section 401, which consists of the liquid crystal touch panel and the like, displays the boxes for inputting and displaying character strings, and the GUI screen for displaying the buttons and the like to designate various functions. Further, the hard keys such as numeric keys, a start key and the like, a dial, various function keys and the like are provided on the hard key section 4002. Incidentally, it is possible by using the hard keys provided on the hard key section 402 to input the data such as later-described waiting time data and the like to the input box on the GUI screen displayed on the GUI section 401. Further, a user mode key 402a is provided on the hard key section 402. Thus, it is possible by handling the user mode key 402a to display the GUI screen concerning a user mode (later described in FIG. 7) on the GUI section 401.

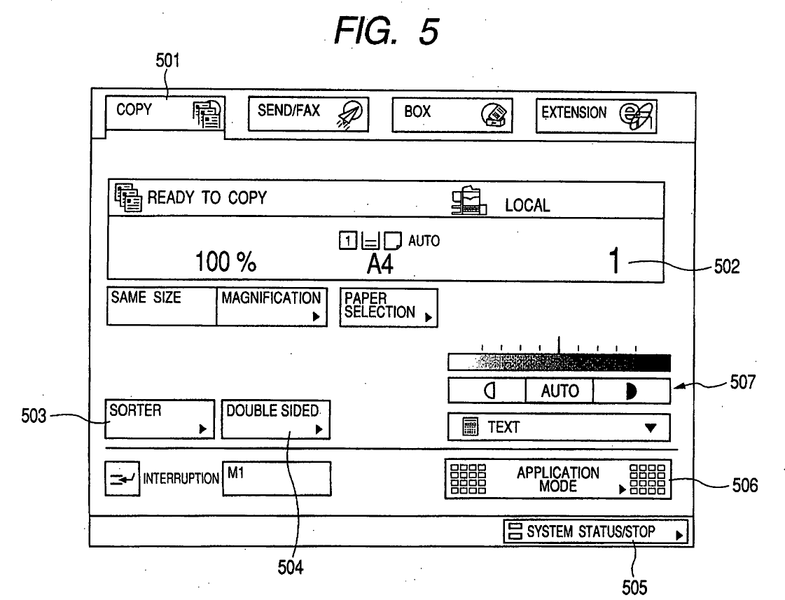

FIG. 5 is a diagram showing the basic GUI screen on which a “COPY” tab 501, a “SEND/FAX” tab, a “BOX” tab and an “EXPANSION” tab corresponding to the respective four functions are displayed. On the GUI screen of FIG. 5, the “COPY” tab 501 is being selected, whereby a display box 502 displays that the device is in the ready-to-copy state, that the current magnification is 100%, that the size of the selected paper is A4, and that the number of copy of “1”.

Further, on the GUI screen of FIG. 5, a sorter button 503 for executing the sorter function, a double-sided function button 504 for executing the double-sided function, an application mode button 506 for proceeding to an application mode, a density button 507 for setting the print density, and the like are displayed. In addition, a status guide section 505 indicates that the system is in the stop state.

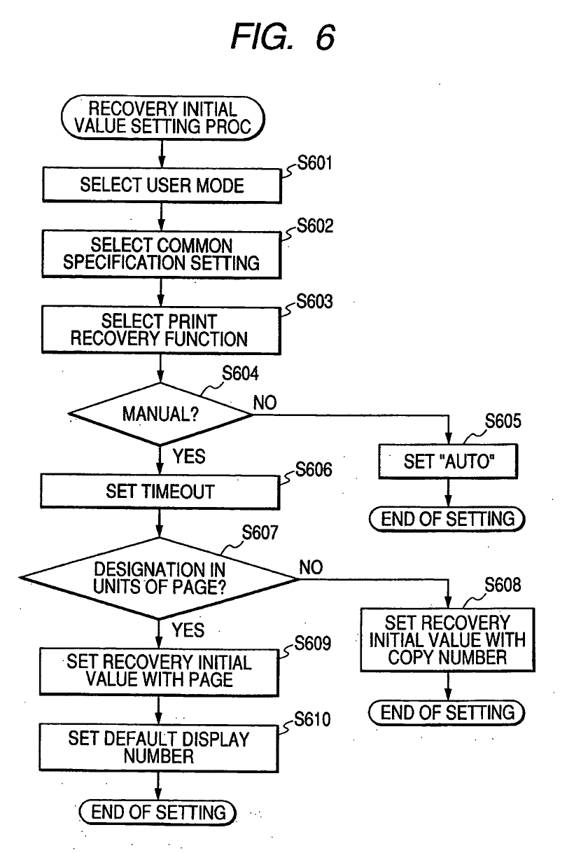

Next, a recovery initial value setting process which is specific in the embodiment will be explained with reference to a flow chart shown in FIG. 6.

If an operator intends to set the recovery initial value when an error occurs, he/she selects the user mode (step S601) by depressing the user mode key 402a on the operation unit 314 shown in FIG. 4. Besides, if a GUI screen (not shown) for selecting various application modes is displayed by touching the application mode button 506 shown in FIG. 5, it is possible to select the user mode on the displayed GUI screen.

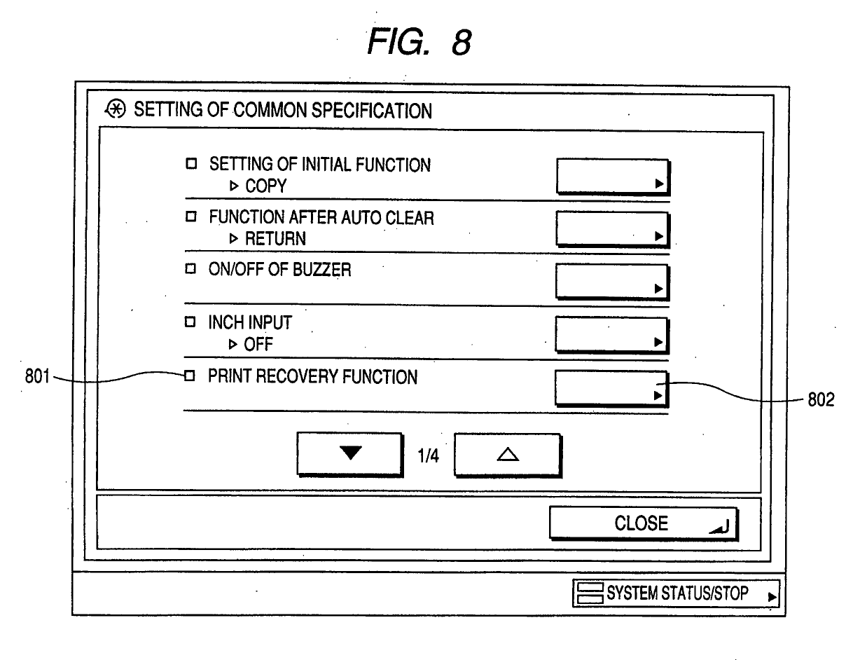

If the user mode key 402a is depressed, the job control unit 301 displays the GUI screen concerning the user mode shown in FIG. 7 on the GUI section 401 of the operation unit 314. Since a “SETTING OF COMMON SPECIFICATION” button 701 is displayed on the GUI screen concerning the user mode, the operator selects the “SETTING OF COMMON SPECIFICATION” button 701 by touching it when he/she sets the recovery initial value (step S602). Then, if the “SETTING OF COMMON SPECIFICATION” button 701 is selected, the job control unit 301 displays the GUI screen shown in FIG. 8 concerning the setting of the common specification on the GUI section 401 of the operation unit 314. On the GUI screen concerning the setting of the common specification, the check boxes and the buttons for selecting the menu items of “SETTING OF INITIAL FUNCTION”, “FUNCTION AFTER AUTO CLEAR”, “ON/OFF OF BUZZER”, “INCH INPUT” and “PRINT RECOVERY FUNCTION” are displayed. Thus, the operator puts a check mark in a check box 801 concerning the menu item of “PRINT RECOVERY FUNCTION” when he/she sets the initial value concerning the print recovery. Next, the operator actually selects the “PRINT RECOVERY FUNCTION” item by touching a corresponding button 802 (step S603).

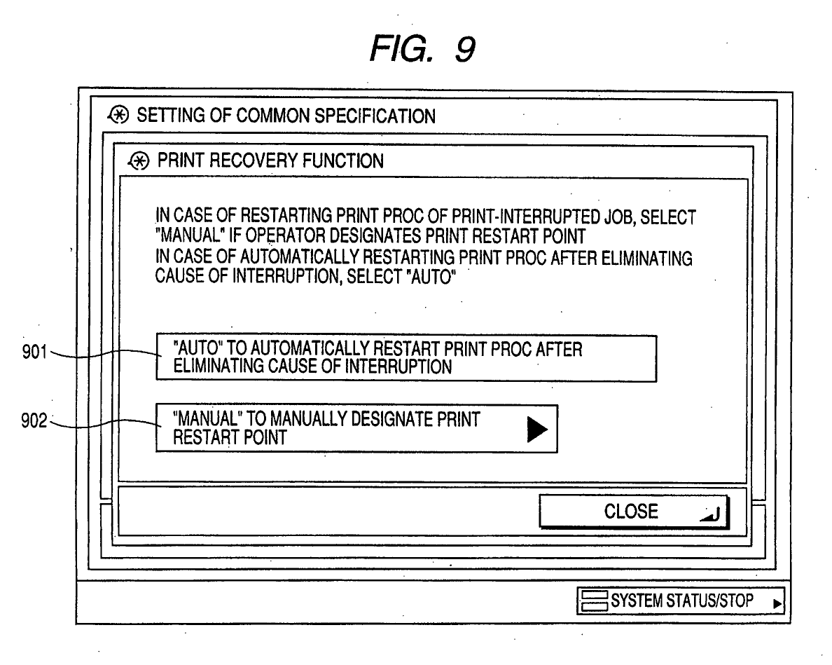

If the “PRINT RECOVERY FUNCTION” item is selected, the job control unit 301 displays the GUI screen shown in FIG. 9 concerning the print recovery function on the GUI section 401 of the operation unit 314. On the GUI screen concerning the print recovery function, an auto restart mode button 901 and a manual restart mode button 902 respectively selecting an automatic restart mode and a manual restart mode as the restart mode in case of restarting the interrupted print process are displayed. Here, it should be noted that the automatic restart mode is the mode of automatically restarting, in case of restarting the once-interrupted print process after eliminating the cause of the interruption, the print process from the restart location that the device judged as the restart location, and that the manual restart mode is the mode of restarting, in case of restarting the once-interrupted print process after eliminating the cause of the interruption, the print process from the location that the operator designated.

The operator arbitrarily selects either the automatic restart mode or the manual restart mode by touching either the auto restart mode button 901 or the manual restart mode button 902 on the GUI screen concerning the print recovery function shown in FIG. 9 (step S604). If the automatic restart mode is selected, the job control unit 301 registers “auto” to the recovery table in the resource management unit 309 (step S605), and then the recovery initial value setting process ends.

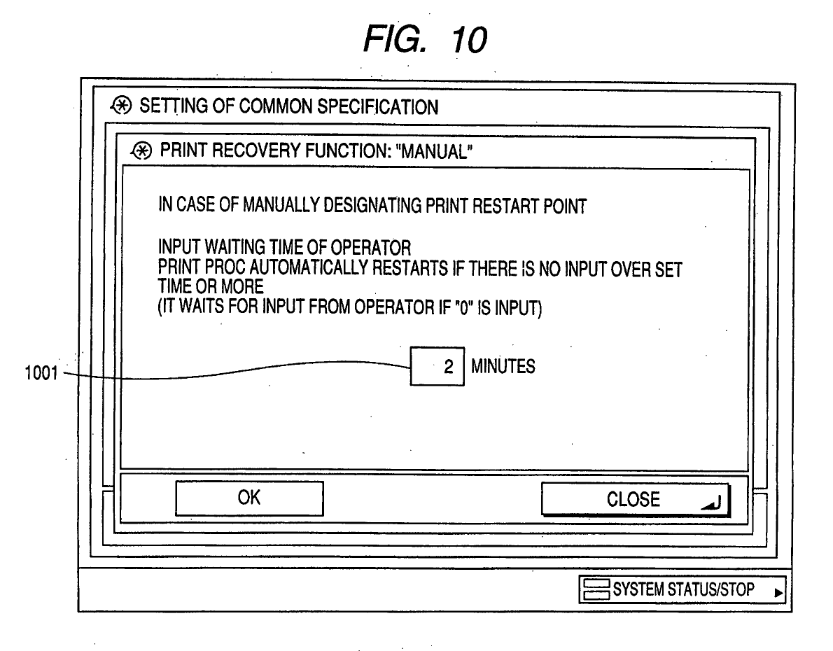

Meanwhile, if the manual restart mode is selected, the job control unit 301 displays the GUI screen shown in FIG. 10 for setting an input waiting time on the GUI section 401 of the operation unit 314. On the GUI screen shown in FIG. 10, a box 1001 for setting the input waiting time when the operator waits for the input operation by the operator is displayed. Thus, the operator can input an arbitrary input waiting time to the box 1001 by using the numeric keys (step S606). Incidentally, it is supposed that the input waiting time is set by using the numeric keys on the GUI screen shown in FIG. 10. However, the present invention is not limited to this. That is, it is possible to enable the operator to easily and promptly set the input waiting time by varying the numeric values displayed in the display box with use of software controller (software manipulator) such as an up/down button or the like.

The input waiting time can be set on the ground that the operator moves away from the settlement location of the device (MFP 131) after release of the interruption cause. More specifically, the input waiting time functions as the time which is necessary to judge “timeout” for releasing the manual restart mode and proceeding to the automatic restart mode, in the case where the print process is interrupted due to the paper jam or the like in the state that the manual restart mode has been set and then the selection of the restart location such as the later-described “designate copy number” operation or the like is not executed before the input waiting time elapses.

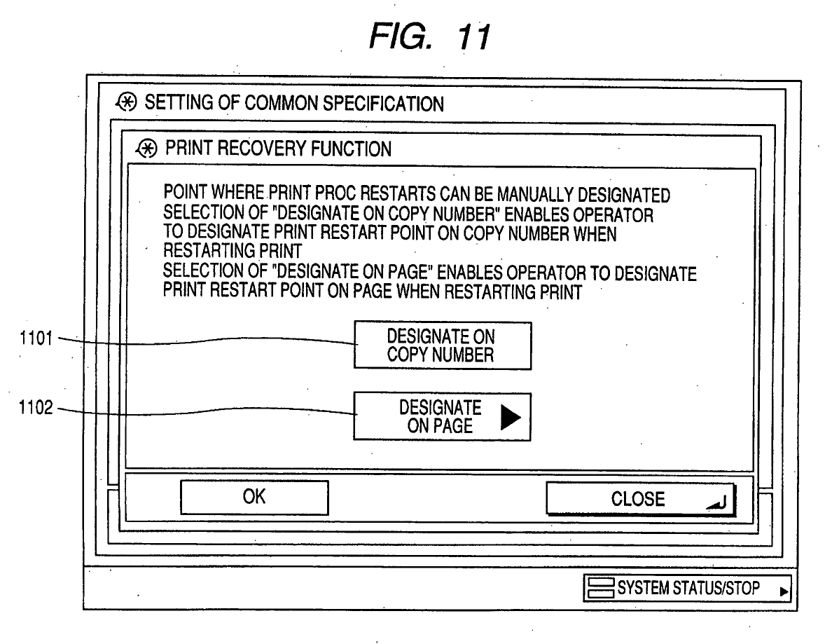

Then, if the operator inputs the input waiting time to the box 1001 and further touches the OK button on the GUI screen shown in FIG. 10, the job control unit 301 displays the GUI screen shown in FIG. 11 for setting units of designation in regard to the restart location on the GUI section 401 of the operation unit 314. Here, on the GUI screen shown in FIG. 11, a “DESIGNATE ON COPY NUMBER” button 1101 and a “DESIGNATE ON PAGE” button 1102 are displayed.

If the operator touches the “DESIGNATE ON COPY NUMBER” button 1101 and further touches the OK button on the GUI screen shown in FIG. 11, the job control unit 301 registers “manual” and “designate on copy number” to the recovery table in the resource management unit 309 (steps S607 and S608), and then the recovery initial value setting process ends. Incidentally, as described later, if “manual” and “designate on copy number” are registered to the recovery table, the operator can designate the print restart location on copy number after releasing the cause of the interruption (for example, after eliminating the paper jammed in the print process).

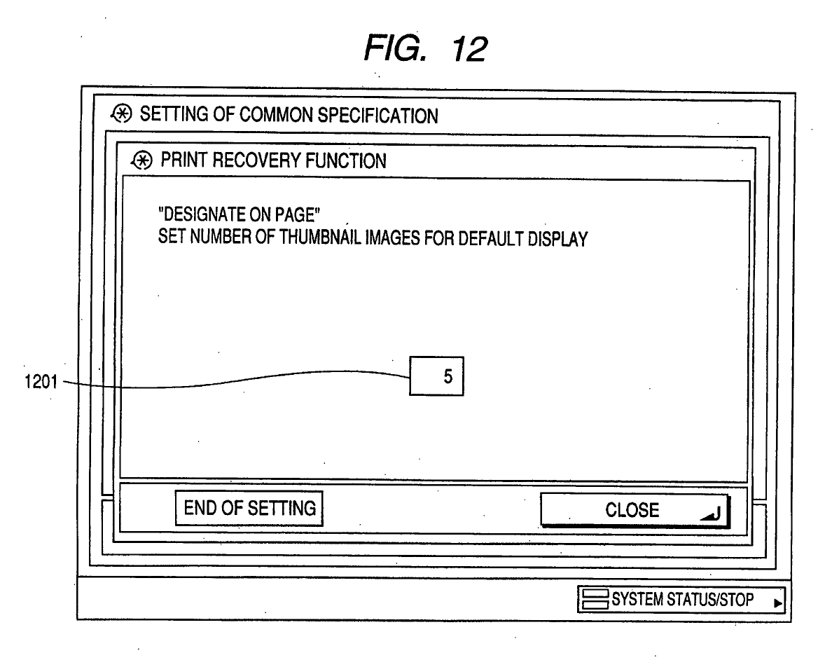

Meanwhile, if the operator touches the “DESIGNATE ON PAGE” button 1102 on the GUI screen shown in FIG. 11 (steps S607 and S609), the job control unit 301 displays, on the GUI section 401 of the operation unit 314, the GUI screen shown in FIG. 12 for previously setting the number of thumbnail images of the image data to be displayed as the restart location candidates.

On the GUI screen shown in FIG. 12, an input box 1201 for inputting the number of thumbnail images to be displayed by default, that is, the number of thumbnail images of the image data to be displayed as the restart location candidates, is displayed. More specifically, the thumbnail images of the image data as the restart location candidates imply the thumbnail images of the image data concerning the location which is judged by the device as the optimum restart location on the occasion of restarting the interrupted process. Further, the number of display images implies the number of displayed images on the occasion of displaying the thumbnail images of the image data at the restart location and the locations before and behind the relevant restart location.

On the GUI screen shown in FIG. 12, the number of thumbnail images to be displayed by default is set to “5”. However, for example, if the number of pages of the print job which is being executed is smaller than the value set on the GUI screen shown in FIG. 12, the actual page number is set as the number of displayed images.

Incidentally, it is supposed that the number of thumbnail images to be displayed by default is input and set by using the numeric keys on the GUI screen shown in FIG. 12. However, the present invention is not limited to this. That is, it is possible to enable the operator to easily and promptly set the number of thumbnail images to be displayed by default by varying the numeric values displayed in the display box with use of software controller such as an up/down button or the like.

If the operator inputs the number of thumbnail images to be displayed by default to the input box 1201 and touches the “END OF SETTING” button on the GUI screen of FIG. 12, the job control unit 301 registers “manual” and “designate on page” to the recovery table in the resource management unit 309 and further registers “the number of thumbnail images” input to the input box 1201 on the GUI screen of FIG. 12 (step S610), and then the recovery initial value setting process ends.

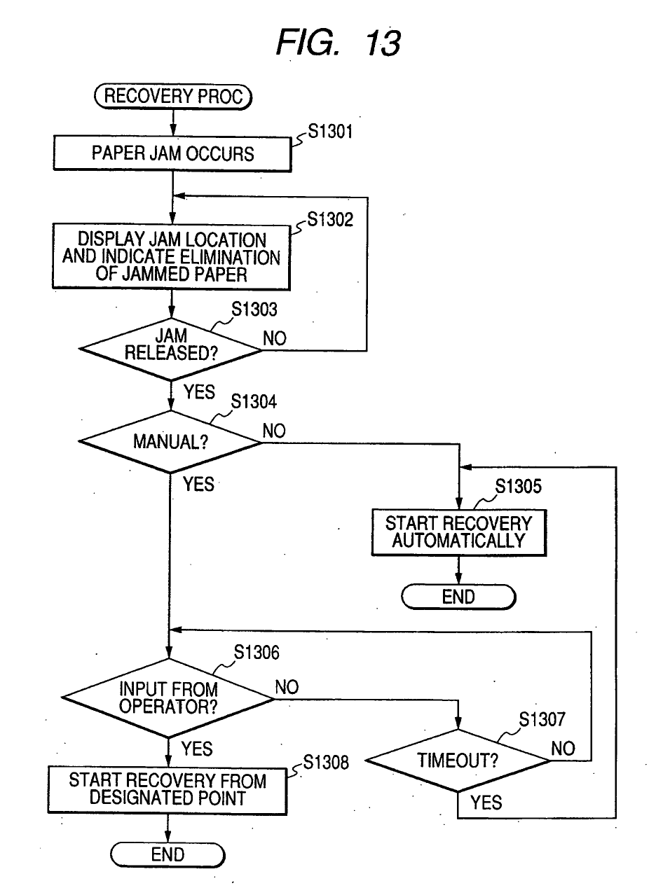

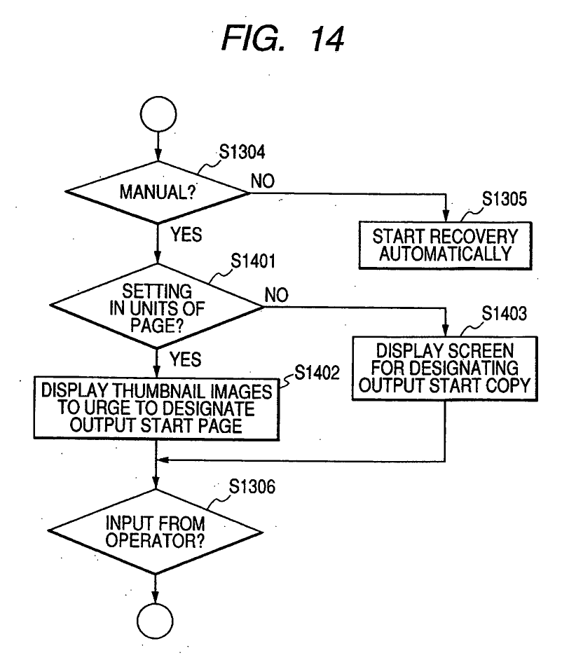

Subsequently, an actual recovery process will be explained with reference to flow charts shown in FIGS. 13 and 14. Here, FIG. 13 is the flow chart showing the outline of the recovery process to be executed when the cause of interruption occurs, and FIG. 14 is the flow chart showing the detailed process in steps S1304 to S1306 of FIG. 13. Incidentally, the flow charts shown in FIGS. 13 and 14 correspond to a case where a paper jam occurs. However, even in a case where another interruption cause such as a transmission error or the like occurs, substantially the same process is executed.

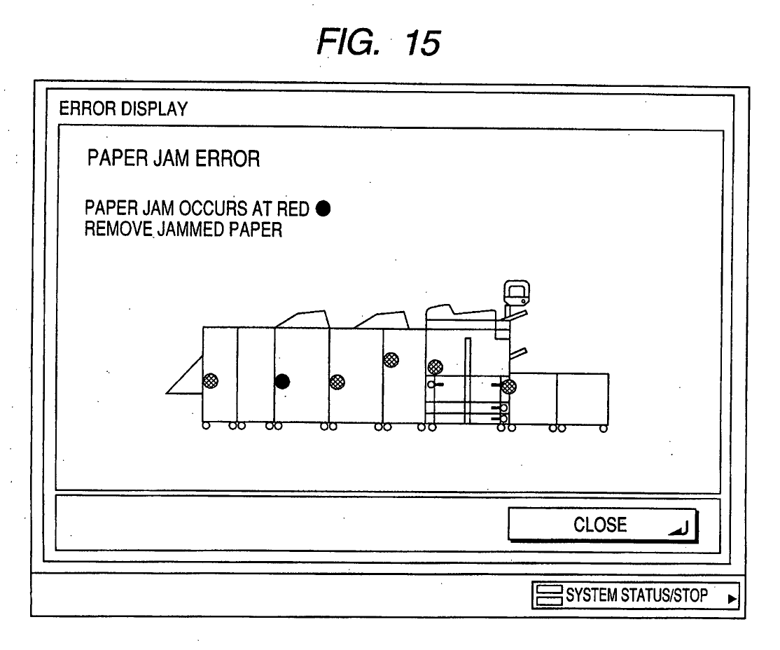

If the paper jam occurs while the sequential print process is being executed (step S1301), as shown in FIG. 15, the guidance information for guiding to eliminate the jammed paper from the device, the image showing the whole of the MFP 131, and the information indicating which location in the MFP 131 the paper jam occurs are displayed on the GUI section 401 of the operation unit 314 (step S1302). Incidentally, in FIG. 15, each of the hatched circles indicates the location that the MFP 131 can discriminate as the paper jam occurrence location in relation to the paper jam sensor locations or the like, and only the circles at the locations that the MFP 131 discriminates as the paper jam occurrence locations are displayed in red. In fact, the black circle in FIG. 15 indicates the location which is practically displayed in red.

Next, the job control unit 301 discriminates whether or not the jammed paper is eliminated (step S1303). If it is discriminated that the jammed paper is not eliminated, the flow returns to the step S1302 to continue the image display process shown in FIG. 15. Meanwhile, if it is discriminated that the jammed paper has been eliminated, the job control unit 301 further discriminates whether or not “manual” has been registered to the recovery table in the resource management unit 309 (step S1304). Thus, if it is discriminated that “auto” has been registered instead of “manual”, the job control unit 301 automatically restarts the print process from the location that the job control unit 301 discriminates as the optimum restart location (step S1305).

Incidentally, it should be noted that the print restart location, that is, the automatic recovery start location, can be discriminated in units of either page or number of print copies. In this case, it is desirable to previously set whether to discriminate the print restart location in units of page or in units of number of print copies and then to actually discriminate the print restart location in units of page or in units of the number of print copies according to such previous setting.

Meanwhile, if it is discriminated that “manual” has been registered to the recovery table in the resource management unit 309, the job control unit 301 further discriminates whether or not “designate on page” has been registered to the recovery table (step S1401). Then, if it is discriminated that “designate on page” has been registered, the job control unit 301 displays, on the GUI section 401 of the operation unit 314, the GUI screen for urging to designate the output start page by displaying the thumbnail images of the image data being the restart location candidates as much as the number of thumbnails registered in the recovery table (step S1402).

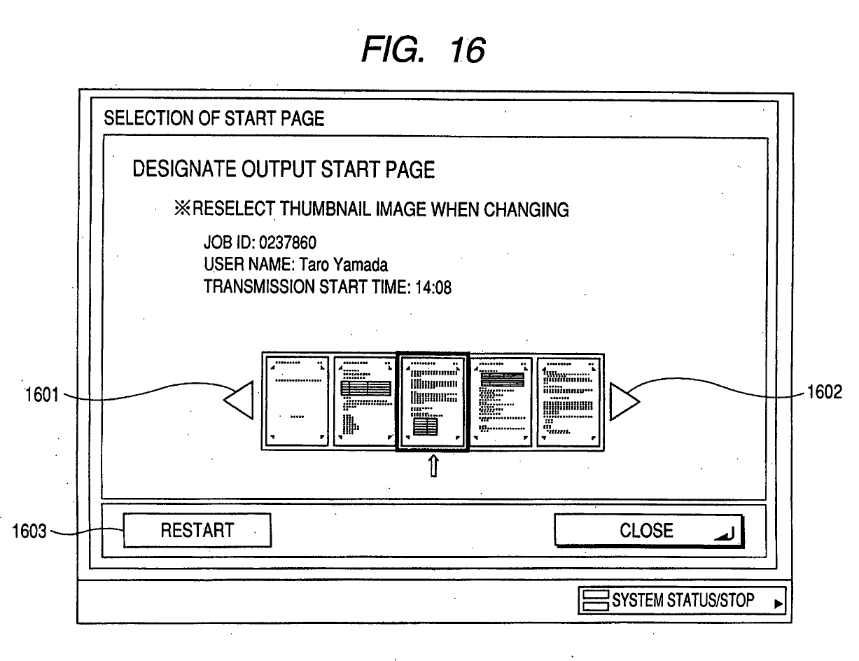

The GUI screen shown in FIG. 16 corresponds to the case where the number of thumbnail images registered on the recovery table is “5”. Thus, on the GUI screen shown in FIG. 16, the five thumbnail images of the image data being the restart location candidates are displayed as the initial values. In this instance, the thumbnail image concerning the image of the page which is discriminated by the job control unit 301 to be optimum as the restart location is shown by using the frame and the arrow. In other words, the job control unit 301 centrally displays the thumbnail image concerning the image of the page which is discriminated by the job control unit 301 to be optimum as the restart location and also displays the thumbnail images of the pages before and behind the central thumbnail image as much as the number of images registered in the recovery table.

Incidentally, after release (or elimination) of the interruption cause, if the thumbnail image of the page that the operator wishes to designate as the restart location is not included in the initially displayed thumbnail images as the restart location candidates, the operator can display the desired thumbnail image by using a left scroll button 1601 or a right scroll button 1602 shown in FIG. 16. Then, the operator designates the restart location by selecting the desired thumbnail image from among the displayed thumbnail images, and depresses a restart button 1603 to indicate the restart process to the job control unit 301.

Further, on the GUI screen displayed in the step S1402, as shown in FIG. 16, the information data such as the job ID, the user name, the document name, the transmission start time and the like may be displayed as the information for specifying the interrupted print job.

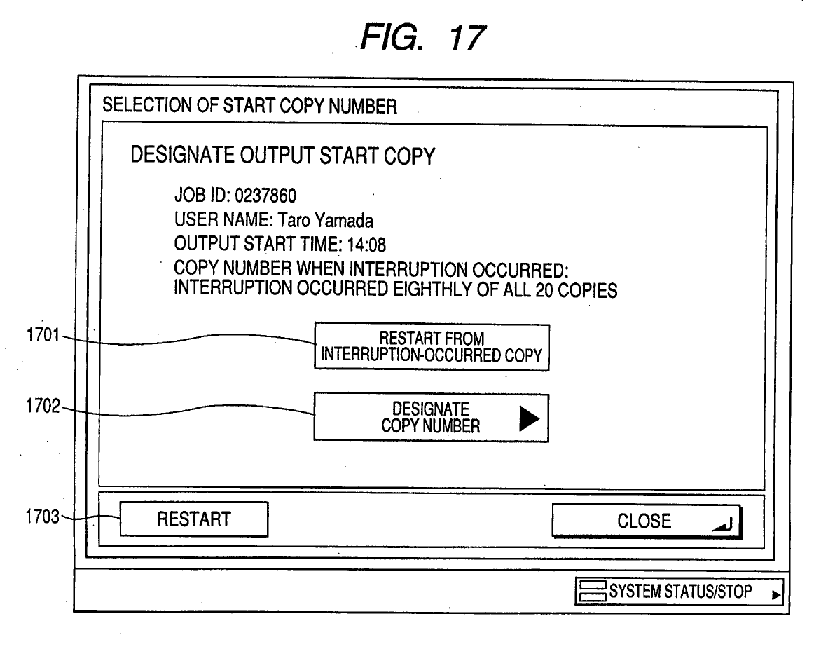

On the other hand, if it is discriminated that “designate on copy number” instead of “designate on page” has been registered in the recovery table (step S1401), the job control unit 301 displays, on the GUI section 401 of the operation unit 314, the GUI screen as shown in FIG. 17 (step S1403). As shown in FIG. 17, on the GUI screen displayed in the step S1402, the information data such as the job ID, the user name, the document name, the output start time and the like are displayed as the information for specifying the interrupted print job. In addition, the number of printed copies when the interruption occurred is displayed. More specifically, in FIG. 17, the information “INTERRUPTION OCCURRED EIGHTHLY OF ALL 20 COPIES” is displayed as the number of printed copies when the interruption occurred. Further, on the GUI screen displayed in the step S1403, also a “RESTART FROM INTERRUPTION-OCCURRED COPY” button 1701, a “DESIGNATE COPY NUMBER” button 1702 and a restart button 1703 are displayed.

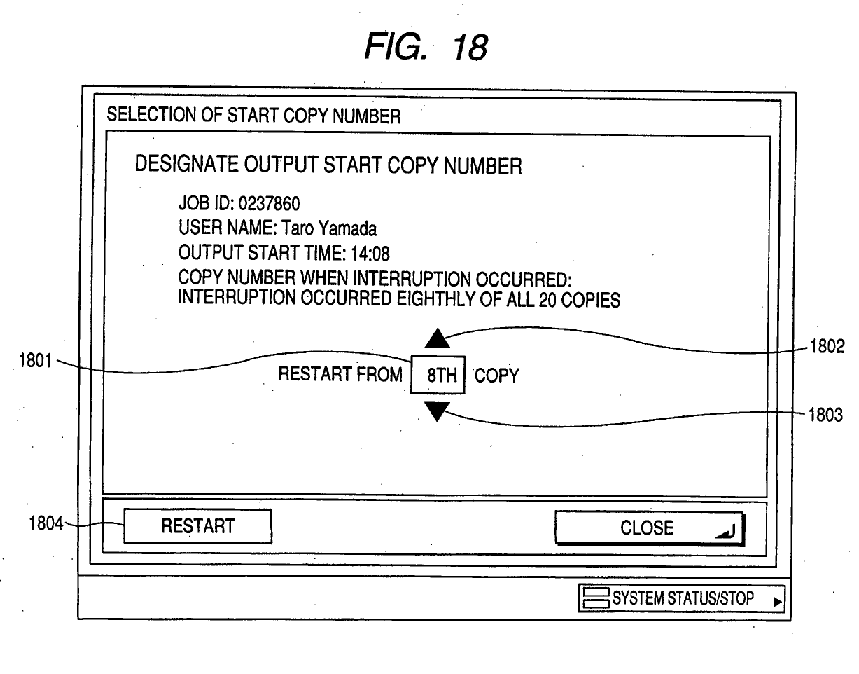

Thus, if the operator wishes to restart the print process from the copy that the interruption occurred, he/she has to depress the “RESTART FROM INTERRUPTION-OCCURRED COPY” button 1701. Meanwhile, if the operator wishes to restart the print process from the designated copy (designated copy number), he/she has to depress the “DESIGNATE COPY NUMBER” button 1702. If the “RESTART FROM INTERRUPTION-OCCURRED COPY” button 1701 is depressed, the job control unit 301 restarts the print process from the first page in the copy that the interruption occurred. Meanwhile, if the “DESIGNATE COPY NUMBER” button 1702 is depressed, the job control unit 301 displays the GUI screen shown in FIG. 18 on the GUI section 401 of the operation unit 314.

The number of print copies at a time when the interruption occurs is displayed as the initial value of the copy number on a display box 1801 of the GUI screen which is displayed when the “DESIGNATE COPY NUMBER” button 1702 is depressed. Here, if the operator changes the numeric value to be displayed in the display box 1801 by using an up button 1802 or a down button 1803 and then depresses a restart button 1804 when the numeric value indicating the desired copy number is displayed in the display box 1801, the print process can be restarted from the first page of the relevant desired copy number.

After the GUI screen as shown in FIG. 16 was displayed in the step S1402, or after the GUI screen shown in FIG. 16 or the GUI screens shown in FIGS. 17 and 18 were displayed in the step S1403, it is judged by the job control unit 301 whether or not the operator executes the input operations respectively on the GUI screens shown in FIG. 16 to 18 (step S1306). Then, if it is judged that the operator does not execute the input operation yet, it is further judged by the job control unit 301 whether or not the input waiting time set in the step S606 of FIG. 6 elapses from the time when releasing the interruption cause in the step S1303 (step S1307).

Then, if it is judged that the input waiting time does not elapse, the flow returns to the step S1306 to cause the job control unit 301 to wait for the input operation by the operator. Meanwhile, if it is judged that the input waiting time elapses (timeout), the flow advances to the step S1305 to cause the control unit 301 to automatically start the recovery operation. That is, if the operator does not designate the restart location or the like until the input waiting time concerning the setting elapses from the time when releasing the interruption cause, the job control unit 301 automatically releases the manual restart mode and proceeds to the automatic restart mode.

By the automatic proceeding process to the automatic restart mode like this, even in a case where the operator is away from the working site of the MFP 131 on urgent business although the interruption cause was released, it is possible to prevent that the print process or the like continues to be interrupted for a long time. Thus, decrease of productivity can be prevented as much as possible. Incidentally, if “0” is set as the input waiting time, the job control unit 301 continues to wait for the input from the operator and does not proceed to the automatic restart mode.

As long as the set input waiting time elapses from the time when releasing the interruption cause, if the operator designates the restart location or the like, the job control unit 301 starts the recovery process from the designated restart location (step S1308).

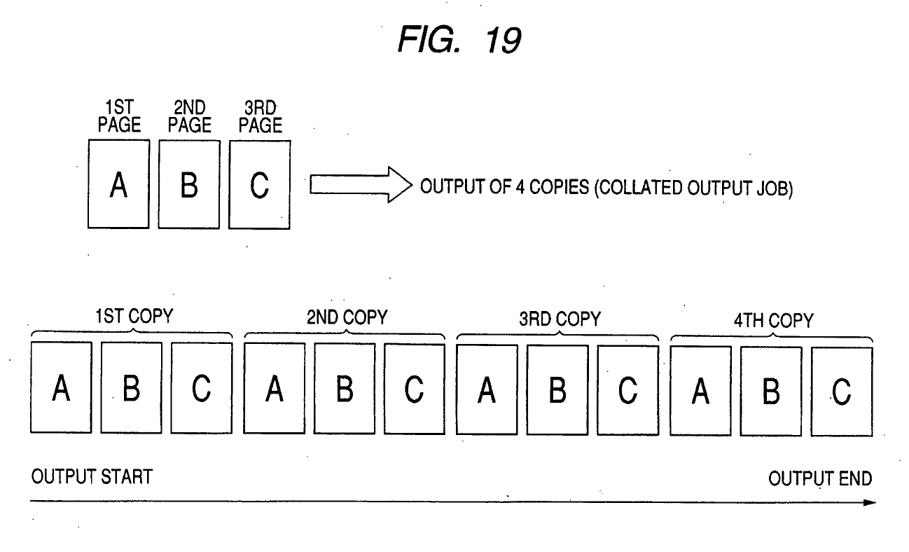

Subsequently, the concrete recovery process will be explained with reference to FIGS. 19 to 22. For example, as shown in FIG. 19, there is a print job of three pages, which prints the character (image) “A” to the first page, the character (image) “B” to the second page, and the character (image) “C” to the third page. Here, it is assumed that the output request of “four copies” is issued in regard to the job of three pages. In this case, if any interruption cause does not occur, the four sets of printed materials (hereinafter called papers) that the characters “A”, “B” and “C” have been printed respectively to the first, second and third pages are generated as shown in FIG. 19.

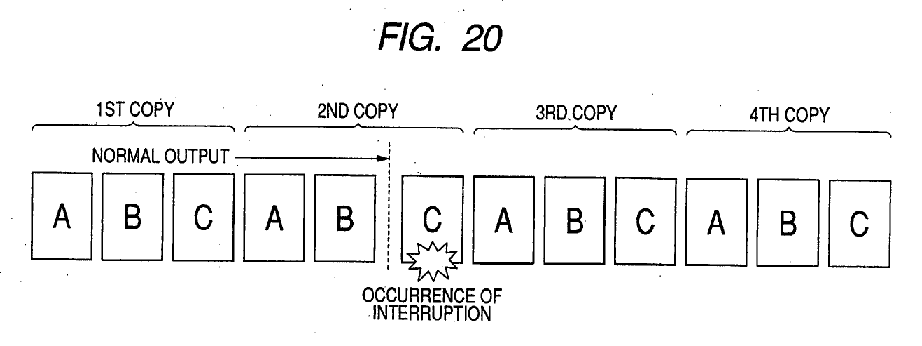

However, as shown in FIG. 20, it is assumed that the papers are normally output up to the paper of the image “B” of the second page of the second copy, and the paper concerning the image “C” of the third page of the second copy is jammed. In this case, at a time when the paper jam occurs, for example, the screen indicating the paper jam location as shown in FIG. 15 is displayed on the GUI section 401 of the operation unit 314. Thus, the operator searches and eliminates the jammed paper from the indicated jammed location or the neighbor location thereof.

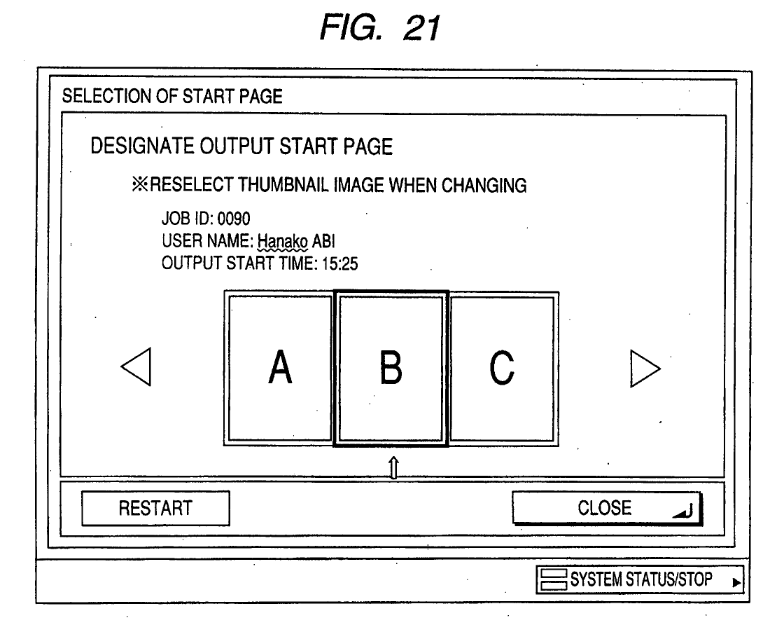

Here, it is assumed that “manual” is set on the GUI screen shown in FIG. 9, “designate on page” is set on the GUI screen shown in FIG. 11, and “3” is set as the number of thumbnail images on the GUI screen shown in FIG. 12. In such a case, if the operator eliminates the jammed paper, the GUI screen shown in FIG. 21 is displayed to urge the operator to designate the print restart page. In this connection, the page of the image “B” judged as the restart location by the job control unit 301 is displayed by highlight on the GUI screen. That is, since various postprocessing devices are connected to such an image forming device as used in the POD system, the job control unit 301 cannot exactly specify the actually output page. Therefore, although the pages up to the page of the image “B” have been actually output, the job control unit 301 judges that it is appropriate to restart the print from the page of the image “B” and thus displays the page of the image “B” by highlight.

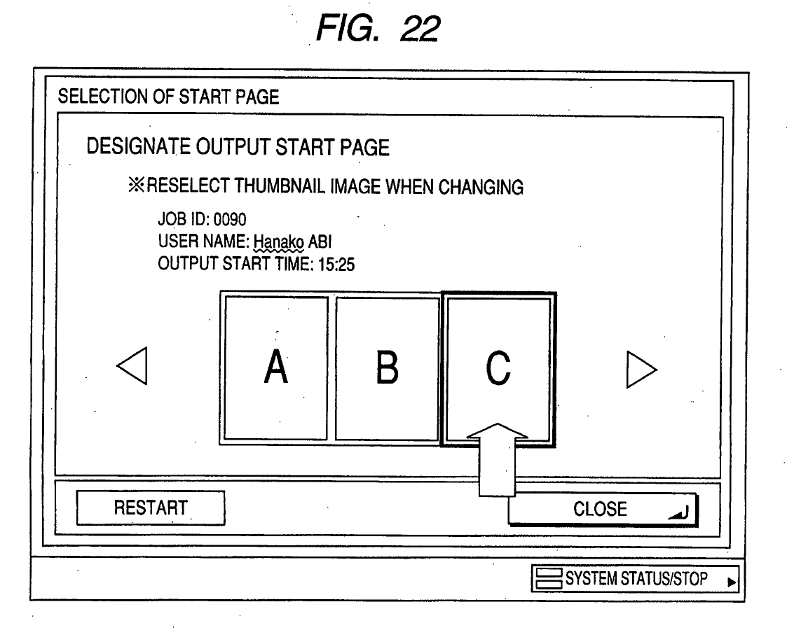

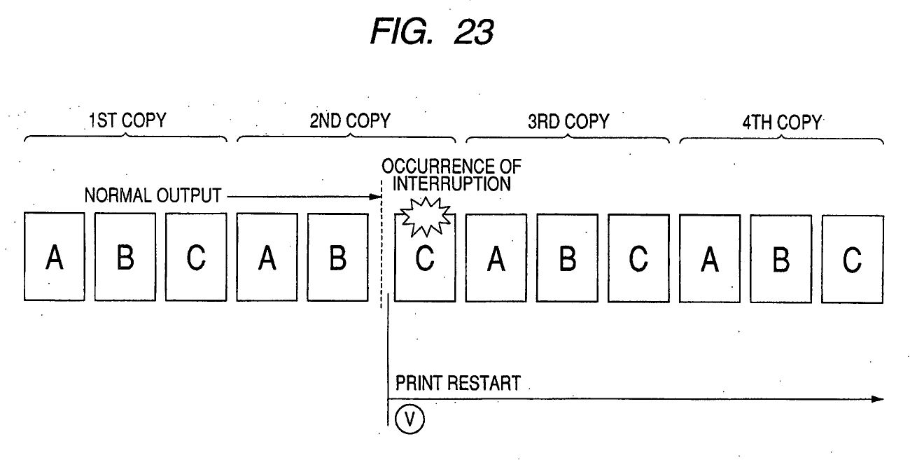

On the other hand, if the operator confirms that the paper of the image “B” of the second page has been surely output, he/she can designate the page of the image “C” as the restart page as shown in FIG. 22 to eliminate that the one copy of the page of the image “B” is redundantly printed (see FIG. 23). Incidentally, in case of designating the page of the image “C” as the restart page, the operator has only to touch the thumbnail image of the page of the image “C”, that is, any complicated operation is unnecessary for the operator. Further, if the thumbnail image of the page of the image “C” is touched, the touched thumbnail image is displayed by highlight, whereby the operator can easily know and grasp that the page of the desired image “C” is recognized as the restart page by the job control unit 301. For this reason, the operator need not confirm page missing and page redundancy after the print process ended, whereby it is possible to save operator's trouble.

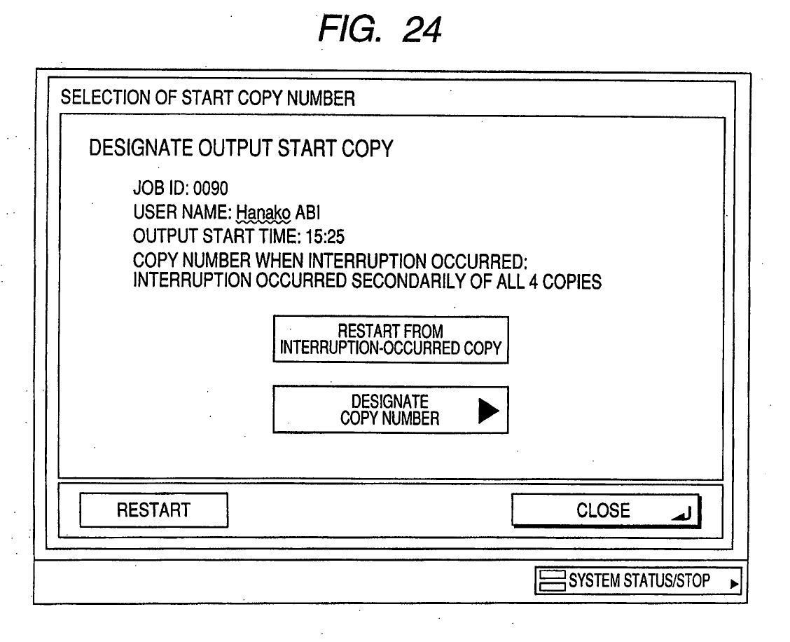

Moreover, it is assumed that “manual” is set on the GUI screen shown in FIG. 9, and “designate on copy number” is set on the GUI screen shown in FIG. 11. In such a case, if the operator eliminates the jammed paper because the paper jam as shown in FIG. 20 occurred during the print job shown in FIG. 19, the GUI screen shown in FIG. 24 is displayed. On the GUI screen shown in FIG. 24, the “RESTART FROM INTERRUPTION-OCCURRED COPY” button and the “DESIGNATE COPY NUMBER” button are displayed. Further, in addition to the information data such as the job ID, the user name, the output start time and the like, the information “INTERRUPTION OCCURRED SECONDARILY OF ALL 4 COPIES” is displayed as the information of the copy number at a time when the interruption occurs.

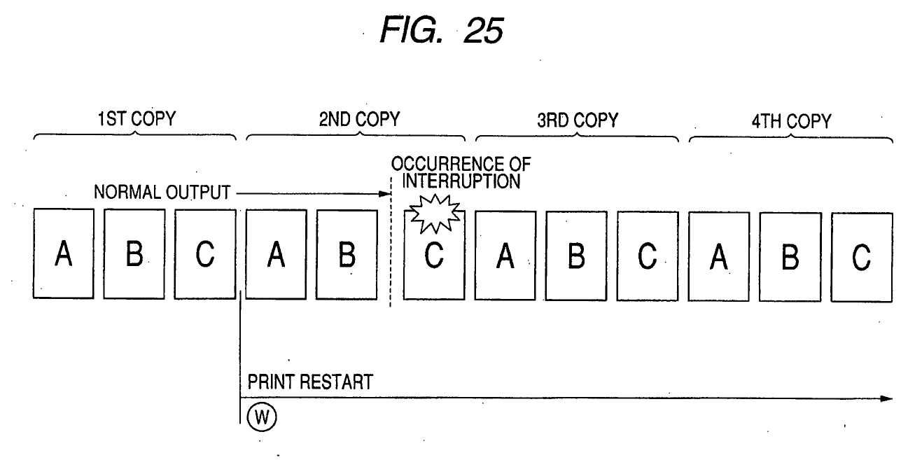

Here, if the “RESTART FROM INTERRUPTION-OCCURRED COPY” button is selected, the print job restarts from the second copy previously displayed as above on the GUI screen. That is, as shown in FIG. 25, if the interruption occurs at the third page of the second copy, the print restarts from the page of the image “A” at the “W” location being the head page of the second copy.

In this case, although the papers of the first and second pages of the second copy have been already discharged, the first and second pages of the second copy are again printed. In this connection, before selecting the “RESTART FROM INTERRUPTION-OCCURRED COPY” button, it is desirable for the operator to eliminate the papers of the first and second pages of the second copy already discharged to the output tray, because of the following reason. That is, in case of removing the redundantly printed papers of the first and second pages after the printing process ended, it is necessary to search the papers of the first and second pages buried in a large number of printed pages (papers). However, in case of removing the papers of the first and second page of the second copy before the printing process restarts, it is possible to easily remove these papers because they have been discharged at the uppermost or lower most part on the output tray.

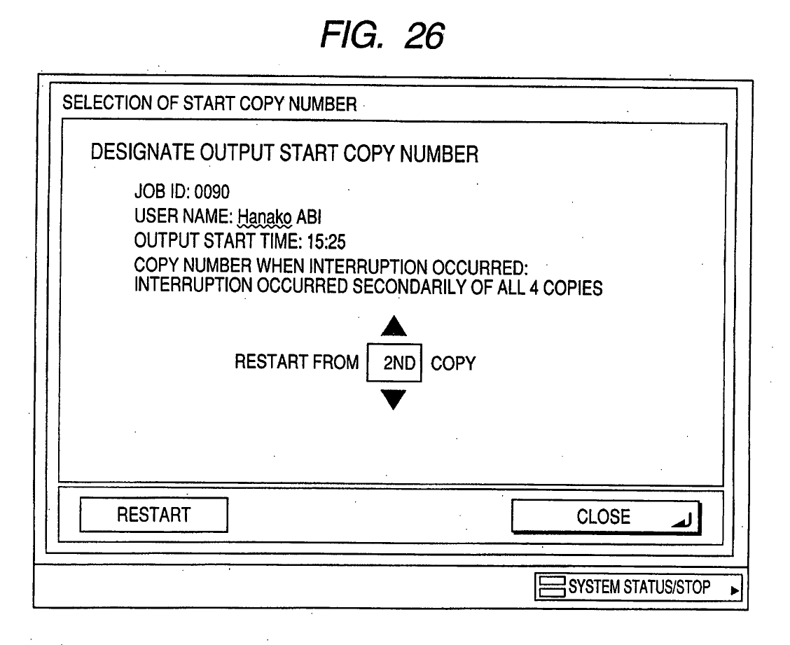

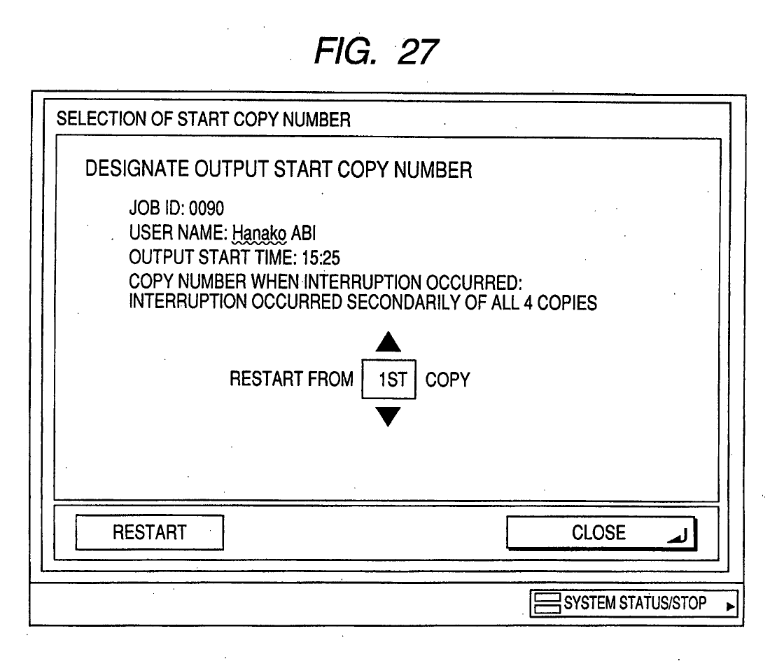

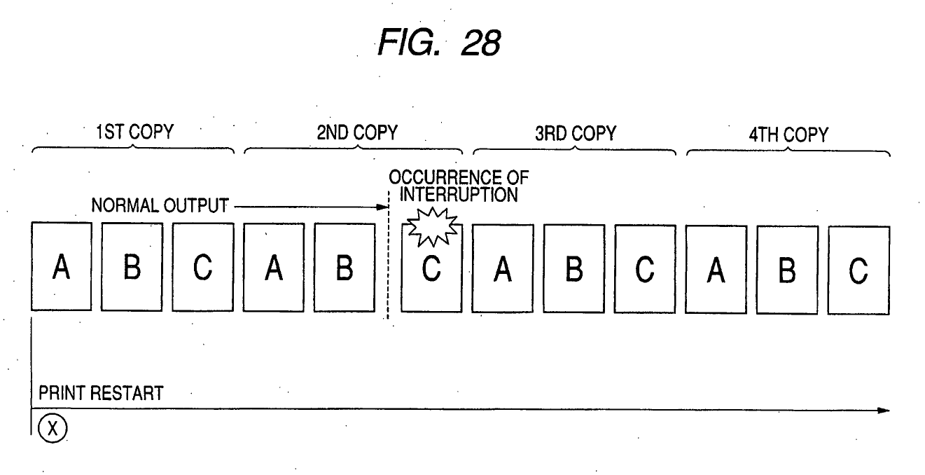

Moreover, if the “DESIGNATE COPY NUMBER” button is selected on the GUI screen shown in FIG. 24, then the GUI screen shown in FIG. 26 is displayed. On the GUI screen shown in FIG. 26, “2” recognized by the job control unit 301 as the interrupted copy number is displayed as the default value of the copy number from which the print process should start. In the circumstances, if the operator wishes to restart the print process from the first copy in consideration of the already output papers, he/she has only to designate “1” and then depress the restart button to restart the print process as shown in FIG. 27. In this case, the print restarts from a point “X” shown in FIG. 28. Thus, as well as the above case, it is desirable for the operator to eliminate the normally output papers of the first page of the first copy to the second page of the second copy at least before depressing the restart button.

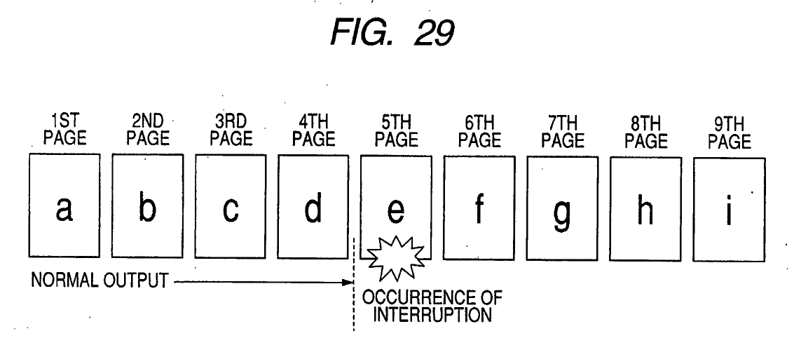

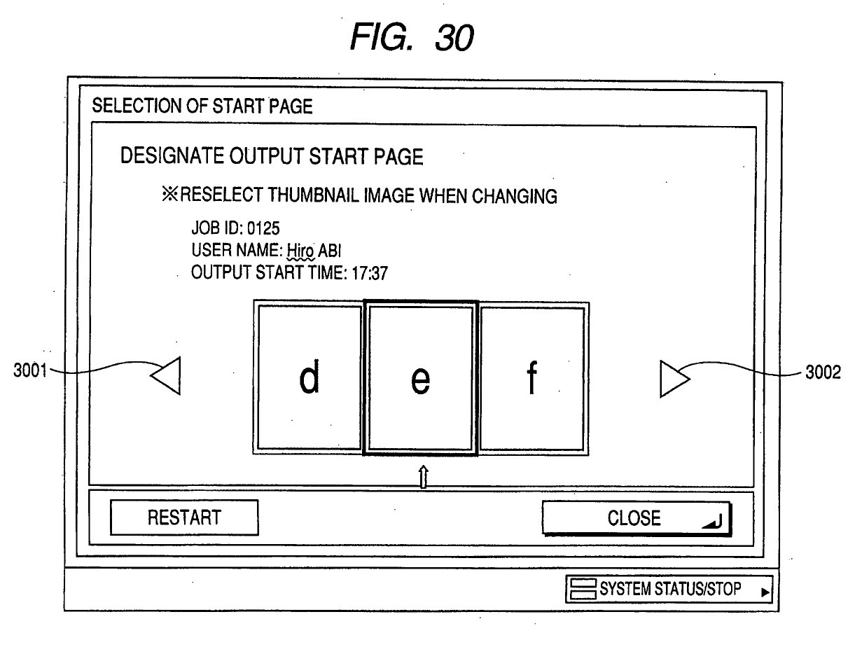

Then, as shown in FIG. 29, an example that, while the job of printing one by one the nine characters “a” to “i” on the respective pages is being executed, the interruption occurs at the image “e” of the fifth page will be explained. In this case, it is assumed that “manual” is set on the GUI screen shown in FIG. 9, “designate on page” is set on the GUI screen shown in FIG. 11, “3” is set as the number of thumbnail images on the GUI screen shown in FIG. 12, and the GUI screen as shown in FIG. 30 is displayed after the jammed paper of the fifth page was eliminated by the operator. Here, the GUI screen shown in FIG. 30 is displayed to urge the operator to designate the print restart page. In this connection, the page of the image “e” judged as the restart location by the job control unit 301 is displayed by highlight on the GUI screen.

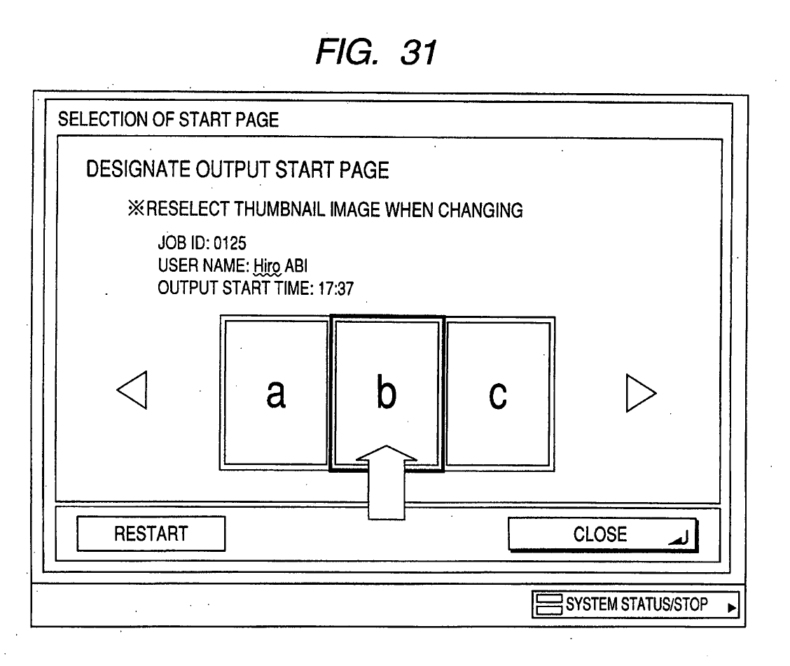

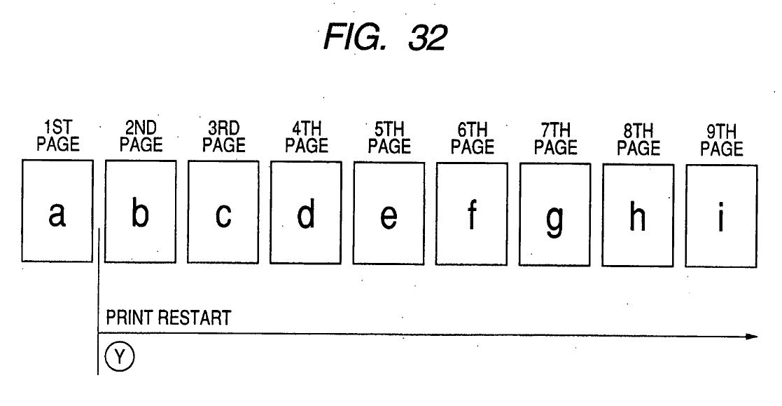

In the circumstances, the operator can of course restart the print process from the image “e” directly. However, it is assumed that the operator checks the print results of the output images “a” to “d”, and thus finds that the first image “a” was normally printed but the papers of the following pages deteriorate by work-up (dirt). In this case, the operator has only to restart, after refilling new papers or eliminating the cause of work-up, the print from the page of the image “b” as shown in FIG. 32. In this connection, to restart the print from the page of the image “b”, the operator has only to scroll the thumbnail images being the display targets by appropriately depressing scroll buttons 3001 and 3002 on the GUI screen shown in FIG. 30 to display the thumbnail image of the desired image “b” as shown in FIG. 31, select the thumbnail image of the desired image “b” to display it by highlight, and depress the restart button.

It should be noted that the above recovery process is applicable not only to the case where en error occurs in the print process but also to the case where an error occurs in the transmission process. More specifically, if a trouble occurs in the transmission path while the image data is being transmitted to an external image processing device or an external computer, there is a case where all the pages cannot be transmitted (that is, a transmission error occurs). Even in this case, it is possible to execute the recovery process of the same kind as that to be executed in case where the error occurs in the print process.

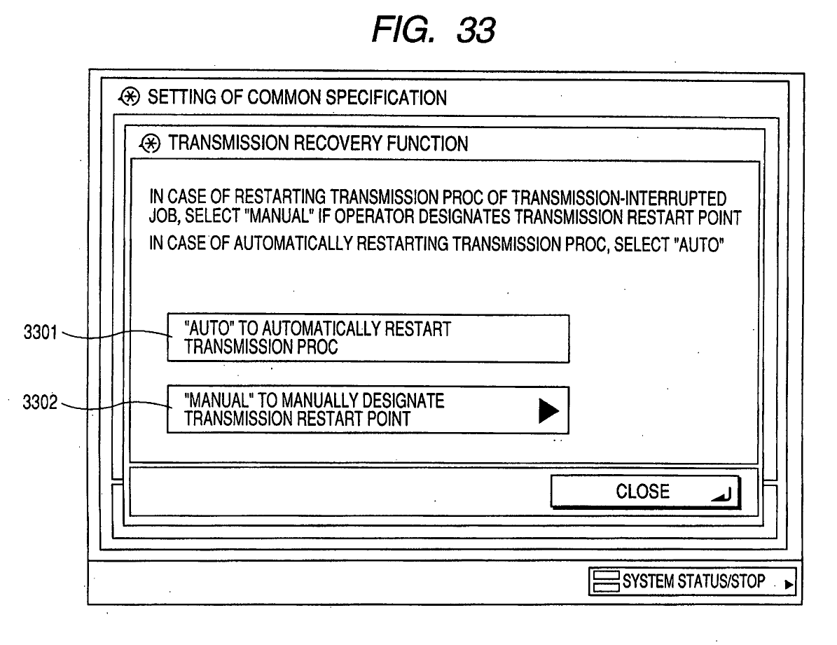

If the transmission error occurs, the job control unit 301 displays such a fact (not shown) on the GUI section 401 of the operation unit 314. Then, the job control unit 301 displays, on the GUI section 401 of the operation unit 314, the GUI screen as shown in FIG. 33 for designating the transmission restart location. On the GUI screen shown in FIG. 33, an automatic restart mode button 3301 for automatically restarting the transmission process from the optimum restart location judged by the job control unit 301 and a manual restart mode button 3302 for restarting the transmission process from the restart location designated by the operator are displayed, whereby the operator can arbitrarily select either the automatic restart mode or the manual restart mode.

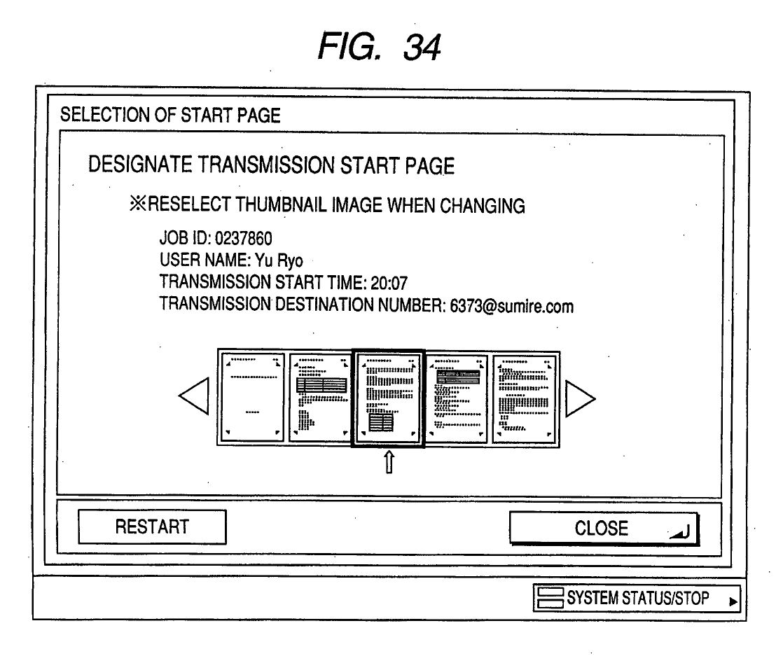

If the operator selects the manual restart mode, the job control unit 301 displays the GUI screen as shown in FIG. 34 on the GUI section 401 of the operation unit 314. On the GUI screen shown in FIG. 34, the thumbnail image of the page of the transmission error judged by the job control unit 301 (hereinafter called the transmission error page) and the thumbnail images of the pages before and behind the transmission error page are displayed. Therefore, if the operator recognizes the actual transmission error page by checking a response or the like from the reception side and then designates the thumbnail image of the recognized transmission error page as the retransmission location, it is possible to avoid the redundant transmission of the same page.

Moreover, in the present embodiment, when the thumbnail images are displayed, the size of each thumbnail image is changed according to the number of thumbnail images to be displayed. More specifically, it is assumed that “manual” is set on the GUI screen shown in FIG. 9, “designate on page” is set on the GUI screen shown in FIG. 11, and “5” is set as the number of thumbnail images to be displayed by default as shown in FIG. 12. In this case, as shown in FIG. 16, the five thumbnail images are displayed in the size conforming to the size of the right and left display space.

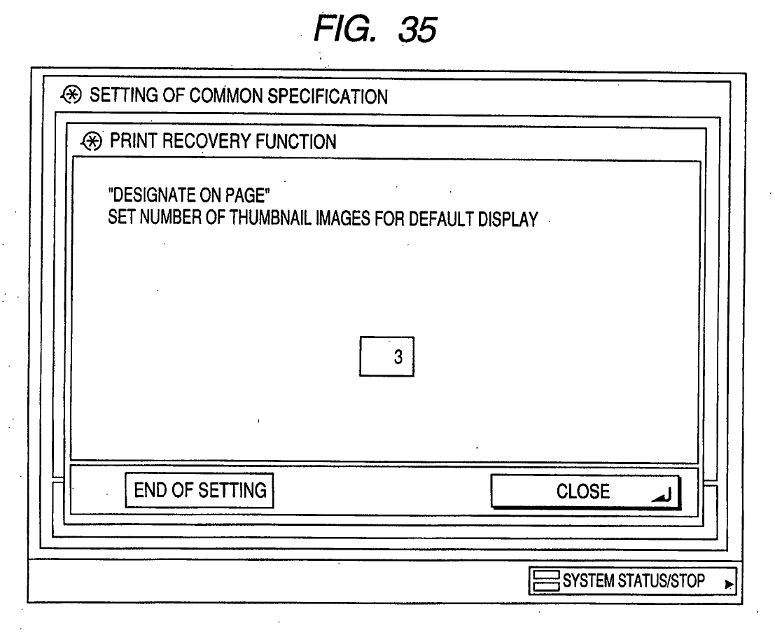

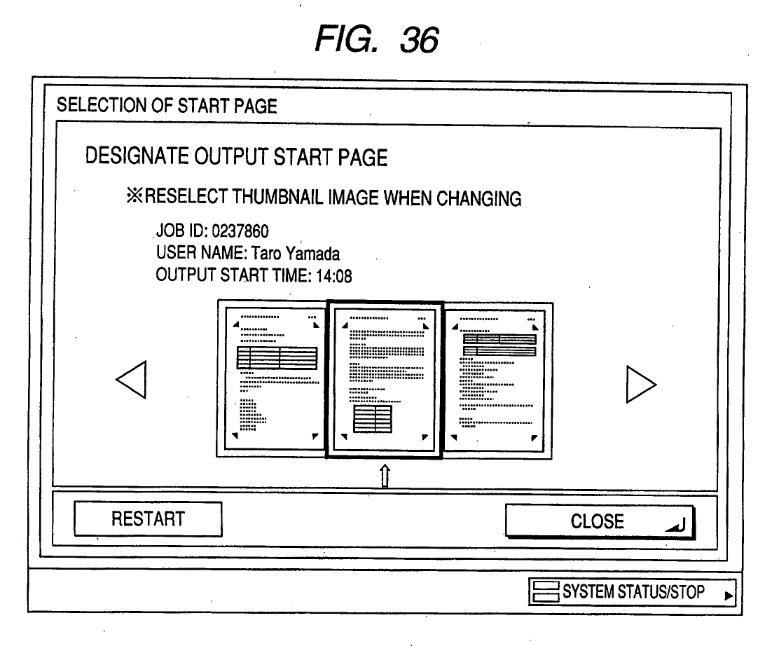

Further, it is assumed that “manual” is set on the GUI screen shown in FIG. 9, “designate on page” is set on the GUI screen shown in FIG. 11, and “3” is set as the number of thumbnail images to be displayed by default as shown in FIG. 35. In this case, as shown in FIG. 36, the three thumbnail images of which the size is larger than that in the case shown in FIG. 16 are displayed so as not to change the aspect ratio of the image shown in FIG. 16. Namely, the thumbnail image displayed on the GUI screen shown in FIG. 36 is the similar-figure enlargement of the thumbnail image displayed on the GUI screen shown in FIG. 16. Incidentally, if “6” or more is set as the number of thumbnail images to be displayed by default, each thumbnail image shown in FIG. 16 is reduced in size and then displayed according to the ratio of the number “6” or more of thumbnail images to the number “5” of thumbnail images. Moreover, the above enlargement/reduction process need not be executed without changing the aspect ratio at any time. That is, it is possible to execute the enlargement/reduction process as properly changing the aspect ratio.

As explained above, according to the present embodiment, when the process such as the print process, the transmission process or the like of the image data is interrupted on the way due to the occurrence of a process error or the like, the GUI screen for designating the restart page of the interrupted process is displayed, and also the thumbnail images of the plural image data concerning the optimum restart page judged on the device side and the pages before and behind the optimum restart page are displayed, so as to be able to be scrolled, as the candidates of restart page on the relevant GUI screen. Thus, it is possible to execute the process such as the print process, the transmission process or the like from the image data concerning the thumbnail image arbitrarily selected and designated by the operator.

More specifically, it is assumed that the print process is interrupted because a paper jam occurs. In this case, after removing the jammed paper, it is possible for the operator to accurately recognize the restart page to which any page missing and page redundancy do not occur by watching the print image on the jammed paper, the print image on the paper discharged to the paper discharge tray disposed in the postprocessing device at the final stage, or the like, select as the restart page the thumbnail image concerning the relevant restart page on the GUI screen, and actually restart the print process by depressing the restart button.

Even in such a case, since any sensor, counter or the like for accurately recognizing the restart page to which any page missing and page redundancy do not occur need not be provided, it is possible to prevent a cost increase in the device. Further, it is possible for the operator to designate the restart page and the like by simply and easily selecting the thumbnail image and depressing the restart button both displayed on the GUI screen. Furthermore, since the restart page to which any page missing and page redundancy do not occur can be accurately designated, it is possible to prevent that a unnecessary page is printed. Therefore, it is possible to reduce the running cost, save the resources and dispense with the operation for checking page missing and page redundancy.

Moreover, in the present embodiment, it is possible to selectively set beforehand the automatic restart mode of automatically restarting the interrupted process from the restart location judged by the device and the manual restart mode of restarting the interrupted process from the restart location designated by the operator. Therefore, for example, in a case where the operator cannot always stand by the location where the relevant device has been settled, it is possible, by previously setting the automatic restart mode, to avoid that the process is interrupted for a long time. Therefore, it is possible to prevent as much as possible that productive efficiency decreases, whereby convenience improves.

Moreover, in the case where the manual restart mode is set, even if the input for designating the restart location is not executed for a predetermined time or more, it is possible to set the waiting time for automatically restarting the interrupted process from the restart location judged on the device side. Also, in this respect, it is possible to avoid that the process is interrupted for a long time. Therefore, it is possible to prevent as much as possible that productive efficiency decreases, whereby convenience improves.

In addition, the restart location can be designated not only in units of page but also in units of copy number. Here, if the restart location is designated in units of copy number, the copy number concerning the interruption judged on the device side is displayed as default-selected copy number. Unlike the page, the copy number judged on the device side is correct. Thus, for example, if the operator is busy, it is possible for him/her to restart the print process from the default-selected copy number displayed on the screen by depressing the restart button after eliminating the jammed paper. By doing so, it is possible to spare the operator the trouble of correctly judging and selecting the copy number concerning the print restart, whereby convenience improves.

Moreover, the thumbnail image concerning the interrupted page and the copy number, judged on the device side, can be displayed in the default-selected state with special form. Also, the software controller for scrolling the displayed thumbnail images and increasing/decreasing the displayed copy number can be displayed. Therefore, it is possible to improve operability and thus easily designate the restart location.

Incidentally, the present invention is not limited to the above embodiment. For example, it is possible to designate the restart location and set the recovery initial value even in a case where the process is interrupted because the memory such as an image memory or the like becomes full of data, in a case where the process is interrupted because toner goes out of existence, in a case where the process is interrupted because power failure occurs, in a case where the process is interrupted because a paper jam occurs in an automatic document feeder, or in a case where the process is interrupted in response to an operator's intentional indication.

Further, the present invention is applicable not only to the MFP which has various functions, but also to another device such as a printer or the like only having an image data print function. Furthermore, the present invention is applicable not only to the image processing device concerning the POD but also to, for example, an image processing device or the like exclusively used in the office.

As explained above, according to the present embodiment, the data processing device as shown in FIG. 2 capable of processing the data of the job to be processed is provided. In this connection, the process of the job interrupted in the data processing device due to the occurrence of interruption cause is controlled by the control unit (for example, the job control unit 301) of the system so as to enable to restart the process by the data processing device after the interruption cause is eliminated.

In this case, the control unit enables to accept the indication for enabling the user to specify which location the process of the interrupted job should restart from, through the user interface unit (for example, the operation unit 314, the GUI section 401, or the like). Further, the control unit controls the data processing device so as to be able to restart the process of the interrupted job from the location concerning the indication accepted through the user interface unit.

For example, in the system of FIG. 2, the print data of the job to be printed by the printer unit 312 is input through at least one of the scanner input unit 302 as the unit capable of inputting the job data having the plural page data being the process target, the facsimile unit 303, the NIC unit 304, the dedicated I/F unit 305 and the USB I/F unit 306.

Then, the job control unit 301 causes the document management unit 307 to store the print data of the input job, reads the print data of the job being the print process target from the document management unit 307, and causes the printer unit 312 to execute the print process of the read print data in units of page. While such a series of processes to the print data of the job being the process target is being executed by the system according to the present embodiment, it is considered that the interruption cause detection unit of the relevant system detects that the interruption cause concerning the print process of the relevant job occurs.

It should be noted that examples of detecting the interruption cause are as follows. That is, (1) in a copy job, an original jam is detected by the original jam sensor of the ADF (automatic document feeder) while the originals of the job to be processed by the ADF are being transported. Further, (2) a recording paper jam occurred in the paper transportation path for transporting the recording papers in the printer unit 312 is detected by the recording paper jam sensor disposed on the paper transportation path. Furthermore, (3) the non-paper state that the paper necessary for printing the data of the job being the process target has gone out of existence is detected by the sheet sensor disposed in the paper feeding cassette of the printer unit 312 and capable of detecting paper presence/absence and a paper remaining amount. Moreover, (4) the non-toner state that the toner necessary in the print process of the job to be printed has gone out of existence is detected by the toner residual amount sensor of the printer unit 312. Moreover, (5) the state that memory full occurs while the job data from the data input unit is being stored in the hard disk or the like of the document management unit 307 is detected by the memory residual amount sensor. Moreover, (6) in the finisher (also called the postprocessing unit 313) which acts as the sheet (paper) processing device capable of executing sheet (paper) processes such as a stapling process, a punching process, a bookbinding process and the like to the image-printed papers transported from the printer unit 312, the trouble that a staple has gone out of existence, a staple jam occurs, or the like is detected by the error sensor of the sheet (paper) processing device.

If the control unit (for example, the job control unit 301) confirms that an event being the interruption cause of the print process of the job occurs while the print process is being executed, the control unit controls the system of the present embodiment so as to interrupt the process of the relevant job.

In addition, the control unit controls to hold the data of all the pages of the interrupted job in, for example, the document management unit 307. Then, the control unit controls to wait for the restart of the process of the job until it is confirmed that at least the interruption cause has been released. Further, the control unit controls to execute the restart process of the job by using the print data held in the document management unit 307, only after the release of the interruption cause.

Incidentally, for example, in the case where the job was interrupted according to the occurrence of original jam, if the control unit (for example, the job control unit 301) confirms, based on the information from the jam sensor in the ADF, that the jammed original in the ADF was eliminated by the operator, the control unit judges that the interruption cause of the job being the process target was released.

Further, for example, in the case where the job was interrupted according to the occurrence of recording paper jam in the printer unit 312, if the control unit confirms, based on the information from the recording paper jam sensor in the printer unit 312, that the jammed recording paper was eliminated by the operator, the control unit judges that the interruption cause of the job being the process target was released.

Furthermore, for example, in the case where the job was interrupted due to the non-paper state, if the control unit confirms, based on the information from the paper sensor of the paper feeding cassette of the printer unit 312, that the papers were resupplied to the paper feeding cassette by the operator, the control unit judges that the interruption cause of the relevant job was released.

Moreover, for example, in the case where the job was interrupted due to the non-toner, if the control unit confirms, based on the information from the toner residual amount sensor of the printer unit 312, that the toner necessary in the print process was resupplied by the operator, the control unit judges that the interruption cause of the relevant job was released.

Moreover, for example, in the case where the job was interrupted due to the memory full, if the control unit confirms that the memory error was released (for example, the data in the document management unit 307 was deleted and thus the free capacity can be secured therein), the control unit judges that the interruption cause of the relevant job was released.

Moreover, for example, in the case where the job was interrupted due to the trouble of the sheet (paper) processing device (for example, the staple jam, the non-staple, the paper jam in the sheet (paper) processing device, or the like), if the control unit confirms, based on the information from the sensor of the sheet (paper) processing device, that the trouble was released by the operator, the control unit judges that the interruption cause of the relevant job was released.

Then, the control unit (for example, the job control unit 301) controls the printer unit 312 so as to restart the interrupted job after the release of the above interruption cause.

Under such a premise, in the system according to the present embodiment, it is controlled to show the user interface for causing the operator to indicate from which location the print process of the interrupted job should restart and to accept the operator's indication of the relevant restart location from the user interface. Here, it should be noted that the user interface is the visual GUI screen in the present embodiment. However, the present invention is not limited to this. That is, it is also possible to use the user interface applicable to another sense such as acoustic sense (voice or the like) or tactual sense (concavity and convexity, vibration, or the like). Then, the control unit controls the printer unit 312 to restart the print process of the interrupted job from the location indicated by the operator through the user interface.

Concretely, the control unit executes the following control. For example, it is first assumed that, in the job of the 50 pages, the print process of the first page to the 24th page ends, and then the print process of the relevant job is interrupted due to the occurrence of the above interruption cause while the print process of the 25th page is being executed. In this case, even if the interruption cause of the relevant job is released through the above user operation, the control unit controls the printer unit 312 or the like to prohibit the operation of automatically restarting the process from the print process of the 25th page.

In the present embodiment, according to the release of the interruption cause, the control unit displays, on the display unit of the user interface, the predetermined operation screen (GUI screen) on which the thumbnail images of the 23rd page→the 24th page→the 25th page→the 26th page→the 27th page are displayed, for example, from left to right in the selectable manner as the candidates of restart page. Thus, the control units causes to execute the preview display of arranging in the selectable manner the thumbnail images of the plural pages as centering the job page being in the process when the interruption cause occurs as the candidates of restart page, so that the operator can easily indicate the restart location of the print process.

Incidentally, it should be noted that the candidates of the restart location to be displayed in the selectable manner are not limited to the thumbnail images. That is, for example, it is possible to display the candidates in another form such as a character string “23rd page”, “23rd page of 2nd copy”, or the like.

In the above example, if the indication to restart the job from the 23rd page is input, the control unit controls to execute, after the release of the interruption cause, the print process from the 23rd page to the 50th page as the recovery process for the process of the relevant job. In other words, if the indication is input from the operator, the control unit controls to again execute the print process of the certain pages in the recovery process even if the print process of the relevant pages normally ended (the 23rd page and the 24th page in the above example).

Incidentally, if the indication to restart the job from the 28th page is input, the control unit controls to execute, after the release of the interruption cause, the print process from the 28th page to the 50th page as the recovery process for the process of the relevant job. In other words, if the indication is input from the operator, the control unit controls not to execute (that is, controls to skip) the print process of the page that the error occurs but to execute the print process from the subsequent page.

Further, if the indication to restart the job from the 25th page that the print interruption occurs is input, the control unit controls to execute, after the release of the interruption cause, the print process from the 25th page to the 50th page as the recovery process for the process of the relevant job. In other words, if the indication is input from the operator, the control unit controls to restart the print process from the page that the print interruption occurs.

Moreover, the control unit controls to enable the operator to previously set the number and size of thumbnail images to be arranged and displayed simultaneously on the same screen, and also controls to enable the operator to change through the user interface unit the previously set number and size of thumbnail images.

Furthermore, the control unit controls to prohibit from executing the above automatic recovery operation (that is, the operation of restarting, according to the release of the interruption cause, the process from the page which is in the process when the interruption cause occurs and of which the process does not end, without any indication from the operator). In addition, in case of executing the mode of causing the operator to designate the recovery location, the control unit controls to enable the user to indicate the restart location not only in units of page but also in units of copy number.

For example, it is assumed that, in a case where the print process for the job of 50 copies (50 sets) each copy consisting of 10 pages is executed, the print process for the first to 14th copies ends, the above interruption cause occurs while the print process of the third page of the 15th copy is being executed, and the control unit controls to immediately interrupt the print process of the third page of the 15th copy in the state that the relevant print process does not end.

In the circumstances, in preparation for the case of automatically restarting the process of the relevant job, the control unit holds all the data of the 10 pages of the relevant job in the memory. Also, the control unit wholly holds the automatic print restart condition information such as the number of output copies or the like (that is, the information of the third page of the 15th copy in the present embodiment). However, even if the interruption cause of the relevant job is released, the control unit prohibits from automatically executing the recovery process from the print process of the third page of the 15th copy.

Then, for example, if the interruption cause is released in the relevant job, the control unit causes to display by the user interface unit the above operation screens, so as to enable the operator to arbitrarily designate to restart the print process of the relevant job from which page or from which copy.

For example, it is assumed that the indication for restarting the job from the 13th copy is input. In this case, after the release of the interruption cause in the relevant job, the control unit controls to execute the print process from the first page (page 1) of the 13th copy to the last page (page 10 in this case) of the 50th copy as the recovery process for the process of the relevant job. Further, if the indication is input from the operator, after the release of the interruption cause in the relevant job, the control unit controls to execute the print process of the sheaf of outputs to which the print process has normally ended, as the recovery process. In this case, it should be noted that the number of output copies to be printed is necessarily larger than the initially expected number of output copies.

Furthermore, in the case where the indication for restarting the job from the 16th page is input, after the release of the interruption cause in the relevant job, the control unit controls to execute the print process from the first page (page 1) of the 16th copy to the last page (page 10 in this case) of the 50th copy as the recovery process for the process of the relevant job. As just described, according to an operator's indication, the control unit executes the control so that the total number of finally printed output copies becomes lower than the initially expected number of output copies (150 copies in this case).

Moreover, in the case where the indication for restarting the job from the 15th copy, after the release of the interruption cause in the relevant job, the control unit controls to execute the print process from the first page (page 1) of the 15th copy to the last page (page 10 in this case) of the 50th copy as the recovery process for the process of the relevant job. As just described, according to an operator's indication, the control unit executes the control so that the total number of finally printed output copies becomes higher than the initially expected number of output copies.

In addition, for example, in the system of FIG. 2, it is assumed that the interruption cause occurs while the data transmission process of the job stored in the hard disk of the document management unit 307 is being executed in units of page by the data transmission unit such as the facsimile unit 303, the NIC unit 304, the dedicated I/F unit 305 or the like which functions as the data transmission unit having, in addition to the data input function, the data output function. In the circumstances, the control unit causes to interrupt the process of the job being the transmission target. Here, it should be noted that the interruption in this case occurs due to an original jam in the ADF, a memory full error in the document management unit 307, a data communication error in the data transmission unit, or the like.

Then, after the release of the interruption cause, the control unit controls to restart by the data transmission unit the transmission process of the job to which the data transmission process was interrupted due to the occurrence of the interruption cause. In this case, the control unit controls to show the user interface for enabling the operator to indicate from which location the transmission process of the interrupted job should be restarted, and to accept the operator's indication of the restart location through the user interface. Here, it should be noted that, although the user interface is the visual GUI screen in the present embodiment, the present invention is not limited to this. That is, it is also possible to use the user interface capable of being applied to another sense such as acoustic sense (e.g., voice), tactual sense (e.g., concavity and convexity, vibration), or the like. Then, the control unit controls the transmission unit to restart the transmission process of the interrupted job from the location indicated by the operator through the user interface.

Incidentally, even in case of controlling the job of the transmission target, as well as the case of controlling the job being the print target as described above, the control unit causes to simultaneously display, on the GUI screen, the thumbnail images of the plural images as centering the interrupted location, the character strings, and the like as the candidates of the restart location in a selectable way. Moreover, in case of controlling the job of the transmission target as described above, the control unit executes the control same as the above control for the job of the print target. That is, for example, the control unit controls to enable the operator to previously set the number of thumbnail images and the size thereof to be simultaneously displayed on the GUI screen.

Further, the object of the present invention can be achieved by supplying the storage medium storing therein the program codes of software to achieve the functions of the above embodiment to a system or a device, and then reading and executing by the computer (CPU or MPU) in the system or the device the program codes stored in the storage medium.

In this case, the program codes themselves read out of the storage medium achieve the functions of the above embodiment, whereby the program codes and the storage medium of storing these program codes constitute the present invention.

As the storage medium for supplying the program codes, for example, a floppy™ disk, a hard disk, a magnetooptical disk, a CD-ROM, a CD-R, a CD-RW, a DVD-ROM, a DVD-RAM, a DVD−RW, a DVD+RW, a magnetic tape, a nonvolatile memory card, a ROM or the like can be used. In addition, the program codes may be downloaded through a network.

Further, the present invention includes not only a case where the functions of the above embodiment are achieved by executing the program codes read by the computer, but also a case where an OS (operating system) or the like running on the computer executes a part or all of the actual processes based on the instructions of the program codes and thus the functions of the above embodiment are achieved by the relevant processes.

Furthermore, the present invention also includes a case where, after the program codes read out of the storage medium are written into the memory on the function expansion board inserted in the computer or the memory provided in the function expansion unit connected to the computer, the CPU or the like provided in the function expansion board or the function expansion unit executes a part or all of the actual processes based on the instructions of the program codes, and thus the functions of the above embodiment are achieved by the relevant processes.

By the above, it is possible to solve the problem raised in the related background art. In addition, it is possible to provide the job processing environment which can execute the recovery operation of the process-interrupted job according to the operator's request as preventing page missing and page redundancy with simple and low-cost constitution.

This application claims priority from Japanese Patent Application No. 2005-099538 filed Mar. 30, 2005, which is hereby incorporated by reference herein.

What is claimed is:

1. A job processing method of a system having a job processing device capable of executing a process necessary in a job, said method comprising the steps of:
enabling to accept, from an operator through a user interface unit, a request for causing said job processing device to execute in the recovery operation of a job a process according to a request of the operator of plural processes being execution targets in the job of which the process was interrupted by occurrence of an interruption cause in the job processing device;
causing the job processing device to execute in the recovery operation of the job the process based on the request after the interruption cause is released; and
enabling to accept, from the operator through the user interface unit, at least one of a second type recovery request and a third type recovery request, different from a first type recovery request for causing the job processing device to execute, in the recovery operation of the job, the process interrupted in the job by the occurrence of the interruption cause without executing the process already executed in the job by the job processing device before the interruption cause occurs,
wherein the second type recovery request is a request for causing the job processing device to again execute, in the recovery operation of the job according to the request of the operator, the process already executed in the job by the job processing device before the interruption cause occurs, and
wherein the third type recovery request is a request for causing to skip, in the recovery operation of the job according to the request of the operator, the process not yet executed in the job by the job processing device before the interruption cause occurs.

2. A job processing method according to claim 1, wherein
said job processing method
enables to accept, from the operator through the user interface unit, the request for causing said job processing device to execute in the recovery operation of the job a print process according to the request of the operator in the job of which the print process in the job processing device was interrupted by the occurrence of a print interruption cause,
enables to execute by the job processing device in the recovery operation of the job the print process based on the request after release of the print interruption cause, and
enables to accept, from the operator through the user interface unit, at least one of the second type recovery request and the third type recovery request, different from the first type recovery request for causing the job processing device to execute, in the recovery operation of the job, the print process interrupted in the job by the occurrence of the print interruption cause without executing the print process already executed in the job by the job processing device before the print interruption cause occurs,
the second type recovery request is a request for causing the job processing device to again execute, in the recovery operation of the job according to the request of the operator, the print process already executed in the job by the job processing device before the print interruption cause occurs, and
the third type recovery request is a request for causing to skip, in the recovery operation of the job according to the request of the operator, the print process not yet executed in the job by the job processing device before the print interruption cause occurs.

3. A job processing method according to claim 1, wherein
said job processing method
enables to accept, from the operator through the user interface unit, the request for causing said job processing device to execute in the recovery operation of the job a transmission process according to the request of the operator in the job of which the transmission process in the job processing device was interrupted by the occurrence of a transmission interruption cause,
enables to execute by the job processing device in the recovery operation of the job the transmission process based on the request after release of the transmission interruption cause, and
enables to accept, from the operator through the user interface unit, at least one of the second type recovery request and the third type recovery request, different from the first type recovery request for causing the job processing device to execute, in the recovery operation of the job, the transmission process interrupted in the job by the occurrence of the transmission interruption cause without executing the transmission process already executed in the job by the job processing device before the transmission interruption cause occurs,
the second type recovery request is a request for causing the job processing device to again execute, in the recovery operation of the job according to the request of the operator, the transmission process already executed in the job by the job processing device before the transmission interruption cause occurs, and
the third type recovery request is a request for causing to skip, in the recovery operation of the job according to the request of the operator, the transmission process not yet executed in the job by the job processing device before the transmission interruption cause occurs.

4. A job processing method according to claim 1, wherein said job processing method causes the user interface unit to show information concerning data of the interrupted job, and thus enables to accept an indication for enabling the operator to specify from which location the process of the interrupted job should be restarted.

5. A job processing method according to claim 1, wherein said job processing method causes the user interface unit to execute preview display of data of the interrupted job as information thereof, and thus enables to accept an indication for enabling the operator to specify from which location the process of the interrupted job should be restarted.

6. A job processing method according to claim 1, wherein, in case of accepting an indication for enabling the operator to specify from which location the process of the interrupted job should be restarted, said job processing method causes by the user interface unit to show plural candidates for the location from which the process of the interrupted job should be restarted, and enables to accept the indication for enabling the operator to specify, from among the plural candidates, from which location the process of the interrupted job should be restarted.

7. A job processing method according to claim 1, wherein said job processing method enables to accept an indication for enabling the operator to specify from which location the process of the interrupted job should be restarted, according to release of the interruption cause.

8. A job processing method according to claim 1, wherein said job processing method causes the user interface unit to execute thumbnail display of data of the interrupted job, and enables the operator to specify through the thumbnail display from which location the process of the interrupted job should be restarted.

9. A job processing method according to claim 1, wherein
said job processing method enables the user interface unit to execute thumbnail display of data of the interrupted job, and
in a case where the interrupted job is a job having data of plural pages, said job processing method enables to display plural thumbnail data for each page on the user interface unit.

10. A job processing method according to claim 1, wherein
in a case where the interrupted job is a job having data of plural pages, said job processing method enables to display plural thumbnail data for each page on a same screen of a display unit of the user interface unit, and
said job processing method enables to restart the job from the page selected from the plural thumbnail data displayed on the screen.

11. A job processing method according to claim 1, wherein
in a case where the interrupted job is a job having data of plural pages, said job processing method enables to display plural thumbnail data for each page on a same screen of a display unit of the user interface unit,
said job processing method enables to restart the job from the page selected from the plural thumbnail data displayed on the screen, and
said job processing method enables the operator to previously select the number of thumbnail data to be displayed simultaneously on the screen.

12. A job processing method according to claim 1, wherein said job processing method causes to interrupt the process of the job, according as at least any of the interruption causes from among an original jam, a recording paper jam, a staple jam, out of paper, out of staple, out of toner, memory full, and user's job interruption indication occurs as the interruption cause.

13. A job processing method according to claim 1, wherein
said job processing method causes to interrupt the process of image data on the way, in the job processing device having at least either an image data print function or an image data transmission function,
said job processing method causes a display unit to display a designation screen for causing to designate a restart location of the interrupted process, and
said job processing method causes to restart the process of the image data from the restart location designated by the operator through the designation screen displayed on the display unit.

14. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit, and
said job processing method further causes
to specify, by the job processing device, the restart location of the interrupted process, and
to display, on the designation screen, a thumbnail image of the image data necessary in the process at the restart location specified by the job processing device and locations before and behind the specified restart location.

15. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location, and
said job processing method further causes
to display, in a particular form, the thumbnail image concerning the restart location specified by the job processing device, as a default restart location.

16. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location, and
said job processing method further causes
to display, on the designation screen, a software manipulator for scrolling the thumbnail image displayed on the designation screen.

17. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location, and
said job processing method enables by the operator to previously register, through the user interface unit, the number of thumbnail images to be displayed on the designation screen.

18. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location, and
said job processing method
enables by the operator to previously register, through the user interface unit, the number of thumbnail images to be displayed on the designation screen, and
causes to display, on the display unit, the thumbnail image in a size corresponding to the number of thumbnail images to be displayed on the designation screen.

19. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location, and
said job processing method enables by the operator to previously register, through the user interface unit, either an automatic mode of automatically restarting the interrupted process at the restart location specified by the job processing device or a manual mode of restarting the interrupted process at the location designated on the designation screen, as an execution-target mode in the job processing device.

20. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the specified restart location and locations before and behind the specified restart location, and
said job processing method enables to execute either a first designation mode of designating the restart location in units of page on the designation screen or a second mode of designating the restart location in units of copy number on the designation screen.

21. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the specified restart location and locations before and behind the specified restart location, and
in case of executing a second mode from among a first designation mode of designating the restart location in units of page on the designation screen and the second mode of designating the restart location in units of copy number on the designation screen, said job processing method causes to display, on the designation screen, the copy number corresponding to the restart location specified by the job processing device, as a default restart location.

22. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by-the job processing device and locations before and behind the specified restart location, and
said job processing method enables by the operator to previously register, through the user interface unit, either an automatic mode of automatically restarting the interrupted process at the restart location specified by the job processing device or a manual mode of restarting the interrupted process at the location designated on the designation screen, as an execution-target mode in the job processing device.

23. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing method further causes
to specify, by the job processing device, the restart location of the interrupted process, and
to display, on the designation screen, a thumbnail image of the image data necessary in the process at the restart location specified by the job processing device and locations before and behind the specified restart location,
said job processing method enables by the job processing device to execute either an automatic mode of automatically restarting the interrupted process at the restart location specified by the job processing device or a manual mode of restarting the interrupted process at the location designated on the designation screen, and
in a case where designation input of the restart location is not executed by the operator through the designation screen even after a predetermined time elapses in the manual mode, the manual mode is switched to the automatic mode.

24. A job processing method according to claim 1, wherein
said job processing method causes
to interrupt the process of image data on the way in the job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit, and
said job processing method further causes to display the designation screen on the display unit according as at least any of the interruption causes from among occurrence of a paper jam in a print process of the image data, occurrence of a transmission error in a transmission process of the image data, and user's job interruption indication occurs.

25. A computer-readable storage medium which stores a computer program to execute a job processing method of a system having a job processing device capable of executing a process necessary in a job, said method comprising the steps of:
enabling to accept, from an operator through a user interface unit, a request for causing said job processing device to execute in the recovery operation of a job a process according to a request of the operator of plural processes being execution targets in the job of which the process was interrupted by occurrence of an interruption cause in the job processing device;
causing the job processing device to execute in the recovery operation of the job the process based on the request after the interruption cause is released; and
enabling to accept, from the operator through the user interface unit, at least one of a second type recovery request and a third type recovery request, different from a first type recovery request for causing the job processing device to execute, in the recovery operation of the job, the process interrupted in the job by the occurrence of the interruption cause without executing the process already executed in the job by the job processing device before the interruption cause occurs,
wherein the second type recovery request is a request for causing the job processing device to again execute, in the recovery operation of the job according to the request of the operator, the process already executed in the job by the job processing device before the interruption cause occurs, and
wherein the third type recovery request is a request for causing to skip, in the recovery operation of the job according to the request of the operator, the process not yet executed in the job by the job processing device before the interruption cause occurs.

26. A job processing device capable of executing a process necessary in a job, comprising:
a user interface controller adapted to be able to accept, from an operator through a user interface unit, a request for causing said job processing device to execute in the recovery operation of a job a process according to a request of the operator from among the plural processes being execution targets in the job of which the process in said job processing device was interrupted by occurrence of an interruption cause in said job processing device; and
a job operation controller adapted to cause said job processing device to execute in the recovery operation of the job the process based on the request after the interruption cause is released,
wherein said user interface controller enables to accept, from the operator through the user interface unit, at least one of a second type recovery request and a third type recovery request, different from a first type recovery request for causing said job processing device to execute, in the recovery operation of the job, the process interrupted in the job by the occurrence of the interruption cause without executing the process already executed in the job by said job processing device before the interruption cause occurs,
wherein the second type recovery request is a request for causing said job processing device to again execute, in the recovery operation of the job according to the request of the operator, the process already executed in the job by said job processing device before the interruption cause occurs, and
wherein the third type recovery request is a request for causing to skip, in the recovery operation of the job according to the request of the operator, the process not yet executed in the job by said job processing device before the interruption cause occurs.

27. A job processing device according to claim 26, wherein
said job processing device
enables to accept, from the operator through the user interface unit, the request for causing said job processing device to execute in the recovery operation of the job a print process according to the request of the operator in the job of which the print process in said job processing device was interrupted by the occurrence of a print interruption cause,
enables to execute by said job processing device in the recovery operation of the job the print process based on the request after release of the print interruption cause, and
enables to accept, from the operator through the user interface unit, at least one of the second type recovery request and the third type recovery request, different from the first type recovery request for causing said job processing device to execute, in the recovery operation of the job, the print process interrupted in the job by the occurrence of the print interruption cause without executing the print process already executed in the job by said job processing device before the print interruption cause occurs,
the second type recovery request is a request for causing said job processing device to again execute, in the recovery operation of the job according to the request of the operator, the print process already executed in the job by said job processing device before the print interruption cause occurs, and
the third type recovery request is a request for causing to skip, in the recovery operation of the job according to the request of the operator, the print process not yet executed in the job by said job processing device before the print interruption cause occurs.

28. A job processing device according to claim 26, wherein
said job processing device
enables to accept, from the operator through the user interface unit, the request for causing said job processing device to execute in the recovery operation of the job a transmission process according to the request of the operator in the job of which the transmission process in the job processing device was interrupted by the occurrence of a transmission interruption cause,
enables to execute by said job processing device in the recovery operation of the job the transmission process based on the request after release of the transmission interruption cause, and
enables to accept, from the operator through the user interface unit, at least one of the second type recovery request and the third type recovery request, different from the first type recovery request for causing said job processing device to execute, in the recovery operation of the job, the transmission process interrupted in the job by the occurrence of the transmission interruption cause without executing the transmission process already executed in the job by said job processing device before the transmission interruption cause occurs,
the second type recovery request is a request for causing said job processing device to again execute, in the recovery operation of the job according to the request of the operator, the transmission process already executed in the job by said job processing device before the transmission interruption cause occurs, and
the third type recovery request is a request for causing to skip, in the recovery operation of the job according to the request of the operator, the transmission process not yet executed in the job by said job processing device before the transmission interruption cause occurs.

29. A job processing device according to claim 26, wherein said job processing device causes the user interface unit to show information concerning data of the interrupted job, and thus enables to accept an indication for enabling the operator to specify from which location the process of the interrupted job should be restarted.

30. A job processing device according to claim 26, wherein said job processing device causes the user interface unit to execute preview display of data of the interrupted job as information thereof, and thus enables to accept an indication for enabling the operator to specify from which location the process of the interrupted job should be restarted.

31. A job processing device according to claim 26, wherein, in case of accepting an indication for enabling the operator to specify from which location the process of the interrupted job should be restarted, said job processing device causes by the user interface unit to show plural candidates for the location from which the process of the interrupted job should be restarted, and enables to accept the indication for enabling the operator to specify, from among the plural candidates, from which location the process of the interrupted job should be restarted.

32. A job processing device according to claim 26, wherein said job processing device enables to accept an indication for enabling the operator to specify from which location the process of the interrupted job should be restarted, according to release of the interruption cause.

33. A job processing device according to claim 26, wherein said job processing device causes the user interface unit to execute thumbnail display of data of the interrupted job, and enables the operator to specify through the thumbnail display from which location the process of the interrupted job should be restarted.

34. A job processing device according to claim 26, wherein
said job processing device enables the user interface unit to execute thumbnail display of data of the interrupted job, and
in a case where the interrupted job is a job having data of plural pages, said job processing device enables to display plural thumbnail data for each page on the user interface unit.

35. A job processing device according to claim 26, wherein
in a case where the interrupted job is a job having data of plural pages, said job processing device enables to display plural thumbnail data for each page on a same screen of a display unit of the user interface unit, and
said job processing device enables to restart the job from the page selected from the plural thumbnail data displayed on the screen.

36. A job processing device according to claim 26, wherein
in a case where the interrupted job is a job having data of plural pages, said job processing device enables to display plural thumbnail data for each page on a same screen of a display unit of the user interface unit,
said job processing device enables to restart the job from the page selected from the plural thumbnail data displayed on the screen, and
said job processing device enables the operator to previously select the number of thumbnail data to be displayed simultaneously on the screen.

37. A job processing device according to claim 26, wherein said job processing device causes to interrupt the process of the job, according as at least any of the interruption causes from among an original jam, a recording paper jam, a staple jam, out of paper, out of staple, out of toner, memory full, and user's job interruption indication occurs as the interruption cause.

38. A job processing device according to claim 26, wherein
said job processing device causes to interrupt the process of image data on the way, in said job processing device having at least either an image data print function or an image data transmission function,
said job processing device causes a display unit to display a designation screen for causing to designate a restart location of the interrupted process, and
said job processing device causes to restart the process of the image data from the restart location designated by the operator through the designation screen displayed on the display unit.

39. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit, and
said job processing device further causes
to specify, by said job processing device, the restart location of the interrupted process, and
to display, on the designation screen, a thumbnail image of the image data necessary in the process at the restart location specified by said job processing device and locations before and behind the specified restart location.

40. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device further causes
to display, in a particular form, the thumbnail image concerning the restart location specified by said job processing device, as a default restart location.

41. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device further causes
to display, on the designation screen, a software manipulator for scrolling the thumbnail image displayed on the designation screen.

42. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device enables by the operator to previously register, through the user interface unit, the number of thumbnail images to be displayed on the designation screen.

43. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device
enables by the operator to previously register, through the user interface unit, the number of thumbnail images to be displayed on the designation screen, and
causes to display, on the display unit, the thumbnail image in a size corresponding to the number of thumbnail images to be displayed on the designation screen.

44. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device enables by the operator to previously register, through the user interface unit, either an automatic mode of automatically restarting the interrupted process at the restart location specified by said job processing device or a manual mode of restarting the interrupted process at the location designated on the designation screen, as an execution-target mode in said job processing device.

45. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the specified restart location and locations before and behind the specified restart location, and
said job processing device enables to execute either a first designation mode of designating the restart location in units of page on the designation screen or a second mode of designating the restart location in units of copy number on the designation screen.

46. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the specified restart location and locations before and behind the specified restart location, and
in case of executing a second mode from among a first designation mode of designating the restart location in units of page on the designation screen and the second mode of designating the restart location in units of copy number on the designation screen, said job processing device causes to display, on the designation screen, the copy number corresponding to the restart location specified by said job processing device, as a default restart location.

47. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location, and
said job processing device enables by the operator to previously register, through the user interface unit, either an automatic mode of automatically restarting the interrupted process at the restart location specified by said job processing device or a manual mode of restarting the interrupted process at the location designated on the designation screen, as an execution-target mode in said job processing device.

48. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit,
said job processing device further causes
to specify, by said job processing device, the restart location of the interrupted process, and
to display, on the designation screen, a thumbnail image of the image data necessary in the process at the restart location specified by said job processing device and locations before and behind the specified restart location,
said job processing device enables by said job processing device to execute either an automatic mode of automatically restarting the interrupted process at the restart location specified by said job processing device or a manual mode of restarting the interrupted process at the location designated on the designation screen, and
in a case where designation input of the restart location is not executed by the operator through the designation screen even after a predetermined time elapses in the manual mode, the manual mode is switched to the automatic mode.

49. A job processing device according to claim 26, wherein
said job processing device causes
to interrupt the process of image data on the way in said job processing device having at least either an image data print function or an image data transmission function,
to display, on a display unit, a designation screen for causing to designate a restart location of the interrupted process, and
to restart the process of the image data from the restart location designated by the operator through the designation screen displayed on the display unit, and
said job processing device further causes to display the designation screen on the display unit according as at least any of the interruption causes from among occurrence of a paper jam in a print process of the image data, occurrence of a transmission error in a transmission process of the image data, and user's job interruption indication occurs.
